(19) United States
(12) Patent Application Publication
(10) Pub. No.: US 2026/0281056 A1
(43) Pub. Date: Sep. 17, 2026

(54) ENHANCEMENTS TO DATA RADIO BEARER PARAMETERS FOR UE-TO-UE RELAYS

(71) Applicant: QUALCOMM Incorporated, San Diego, CA (US)

(72) Inventors: Jianhua LIU, Beijing (CN); Hong CHENG, Basking Ridge, NJ (US); Qing LI, Princeton Junction, NJ (US)

(21) Appl. No.: 19/471,499

(22) PCT Filed: May 10, 2023
(86) PCT No.: PCT/CN2023/093162

§ 371 Date: Oct. 1, 2025

(51) Int. Cl. H04L 47/80; H04L 45/122; H04L 47/17; H04W 72/40

(52) U.S. Cl. CPC H04L 47/805; H04L 45/122; H04L 47/17; H04W 72/40

(57) ABSTRACT

Methods, systems, and devices for wireless communication are described. In some examples, a source user equipment (UE) may receive a control message indicating a set of end-to-end sidelink data radio bearer (DRB) parameters and multiple per-hop sidelink DRB parameters. In such examples, the set of end-to-end sidelink DRB parameters may be associated with communications between the source UE and a destination UE, while the multiple per-hop sidelink DRB parameters may be associated with multiple communication hops, sidelink relay connections, between the source UE and the destination UE. As such, the source UE may transmit, via an end-to-end sidelink interface, control data to the destination UE based on the set of end-to-end sidelink DRB parameters. Further, the source UE may transmit, via a sidelink interface, user data to a relay UE based on a first set of per-hop sidelink DRB parameters, where the user data is intended for the destination UE.

### CROSS REFERENCE

The present Application is a 371 national phase filing of International PCT Application No. PCT/CN2023/093162 by LIU et al., entitled “ENHANCEMENTS TO DATA RADIO BEARER PARAMETERS FOR UE-TO-UE RELAYS,” filed May 10, 2023, which is assigned to the assignee hereof, and which is expressly incorporated by reference in its entirety herein.

### FIELD OF TECHNOLOGY

The following relates to wireless communications, including enhancements to data radio bearer parameters for UE-to-UE relays.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support enhancements to data radio bearer parameters for UE-to-UE (U2U) relays. For example, the described techniques provide for a network entity 105 to configure, and indicate, sidelink data radio bearer (DRB) parameters for multiple per-hop communication links between a source user equipment (UE) and a destination UE and provide a set of end-to-end (E2E) sidelink DRB parameters for an E2E between the source UE and the destination UE for layer 2 (L2) based U2U relay communications. In this way, the source UE and the destination UE may communicate user data via various intermediary relay UEs, thereby expanding coverage area, improving coordination between devices, and providing for a more efficient utilization of communication resources.

A method for wireless communications at a source UE is described. The method may include receiving a control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE, transmitting, via a first sidelink interface, control data to the destination UE in accordance with the set of E2E sidelink DRB parameters, and transmitting, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops.

An apparatus for wireless communications at a source UE is described. The apparatus may include a processor, memory coupled with the processor, and instructions stored in the memory. The instructions may be executable by the processor to cause the apparatus to receive a control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE, transmit, via a first sidelink interface, control data to the destination UE in accordance with the set of E2E sidelink DRB parameters, and transmit, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops.

Another apparatus for wireless communications at a source UE is described. The apparatus may include means for receiving a control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE, means for transmitting, via a first sidelink interface, control data to the destination UE in accordance with the set of E2E sidelink DRB parameters, and means for transmitting, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops.

A non-transitory computer-readable medium storing code for wireless communications at a source UE is described. The code may include instructions executable by a processor to receive a control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE, transmit, via a first sidelink interface, control data to the destination UE in accordance with the set of E2E sidelink DRB parameters, and transmit, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops.

Some examples of the method, apparatuses, and non-transitory computer-readable medium described herein may further include operations, features, means, or instructions for transmitting a second control message indicating an E2E quality of service (QOS) profile associated with the first sidelink interface, a set of multiple QoS profiles associated with the set of multiple communication hops between the source UE and the destination UE, or both, where the set of E2E sidelink DRB parameters may be based on the E2E QoS profile, and where each of the set of multiple per-hop sidelink DRB parameters may be based on a respective quality service profile of the set of multiple QoS profiles.

Some examples of the method, apparatuses, and non-transitory computer-readable medium described herein may further include operations, features, means, or instructions for transmitting, via the second control message, an indication of a quantity of communication hops of the set of multiple communication hops between the source UE and the destination UE, where the set of multiple per-hop sidelink DRB parameters may be further based on the quantity of communication hops of the set of multiple communication hops.

Some examples of the method, apparatuses, and non-transitory computer-readable medium described herein may further include operations, features, means, or instructions for receiving, as part of the control message and based on the second control message, an indication of a first QoS profile of the set of multiple QoS profiles and a subset of the set of multiple QoS profiles, the first QoS profile being associated with the first communication hop between the source UE and the relay, and the subset of the set of multiple QoS profiles being associated with a subset of the set of multiple communication hops, where the subset of the set of multiple communication hops may be between the relay UE and the destination UE.

Some examples of the method, apparatuses, and non-transitory computer-readable medium described herein may further include operations, features, means, or instructions for transmitting, via the second sidelink interface, the subset of the set of multiple QoS profiles to the relay UE.

Some examples of the method, apparatuses, and non-transitory computer-readable medium described herein may further include operations, features, means, or instructions for transmitting, to the destination UE, a sidelink control message indicating the set of E2E sidelink DRB parameters based on receiving the control message, where transmitting the control data to the destination UE may be based on the sidelink control message.

Some examples of the method, apparatuses, and non-transitory computer-readable medium described herein may further include operations, features, means, or instructions for transmitting, to the destination UE, the relay UE, or both, a sidelink control message indicating the set of multiple per-hop sidelink DRB parameters based on receiving the control message, where transmitting the user data via the second sidelink interface may be based on the sidelink control message.

In some examples of the method, apparatuses, and non-transitory computer-readable medium described herein, the control message further indicates that the set of E2E sidelink DRB parameters and the set of multiple per-hop sidelink DRB parameters may be for a UE-to-UE relay operation.

A method is described. The method may include receiving a control message indicating a set of multiple per-hop sidelink DRB parameters, the set of multiple per-hop sidelink DRB parameters associated with a set of multiple communication hops between the relay UE and a destination UE, receiving user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops, and transmitting the user data via a second sidelink interface in accordance with a second set of per-hop sidelink DRB parameters of the set of multiple per-hop sidelink DRB parameters, the second sidelink interface corresponding to a second communication hop of the set of multiple communication hops.

An apparatus is described. The apparatus may include a processor, memory coupled with the processor, and instructions stored in the memory. The instructions may be executable by the processor to cause the apparatus to receive a control message indicating a set of multiple per-hop sidelink DRB parameters, the set of multiple per-hop sidelink DRB parameters associated with a set of multiple communication hops between the relay UE and a destination UE, receive user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops, and transmit the user data via a second sidelink interface in accordance with a second set of per-hop sidelink DRB parameters of the set of multiple per-hop sidelink DRB parameters, the second sidelink interface corresponding to a second communication hop of the set of multiple communication hops.

Another apparatus is described. The apparatus may include means for receiving a control message indicating a set of multiple per-hop sidelink DRB parameters, the set of multiple per-hop sidelink DRB parameters associated with a set of multiple communication hops between the relay UE and a destination UE, means for receiving user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops, and means for transmitting the user data via a second sidelink interface in accordance with a second set of per-hop sidelink DRB parameters of the set of multiple per-hop sidelink DRB parameters, the second sidelink interface corresponding to a second communication hop of the set of multiple communication hops.

A non-transitory computer-readable medium storing code is described. The code may include instructions executable by a processor to receive a control message indicating a set of multiple per-hop sidelink DRB parameters, the set of multiple per-hop sidelink DRB parameters associated with a set of multiple communication hops between the relay UE and a destination UE, receive user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops, and transmit the user data via a second sidelink interface in accordance with a second set of per-hop sidelink DRB parameters of the set of multiple per-hop sidelink DRB parameters, the second sidelink interface corresponding to a second communication hop of the set of multiple communication hops.

Some examples of the method, apparatuses, and non-transitory computer-readable medium described herein may further include operations, features, means, or instructions for transmitting a second control message indicating a set of multiple QoS profiles associated with the set of multiple communication hops between the relay UE and the destination UE.

Some examples of the method, apparatuses, and non-transitory computer-readable medium described herein may further include operations, features, means, or instructions for transmitting, via the second control message, an indication of a quantity of communication hops of the set of multiple communication hops between the relay UE and the destination UE.

Some examples of the method, apparatuses, and non-transitory computer-readable medium described herein may further include operations, features, means, or instructions for receiving, as part of the control message and based on the second control message, an indication of a subset of the set of multiple QoS profiles, the subset of the set of multiple QoS profiles being associated with a subset of the set of multiple communication hops, where in the subset of the set of multiple communication hops may be subsequent to the second communication hop.

Some examples of the method, apparatuses, and non-transitory computer-readable medium described herein may further include operations, features, means, or instructions for transmitting, via the second sidelink interface, the subset of the set of multiple QoS profiles.

In some examples of the method, apparatuses, and non-transitory computer-readable medium described herein, the set of multiple QoS profiles includes a first QoS profile associated with the first sidelink interface, a second QoS profile associated with the second sidelink interface, or both.

Some examples of the method, apparatuses, and non-transitory computer-readable medium described herein may further include operations, features, means, or instructions for transmitting a sidelink control message indicating the set of multiple per-hop sidelink DRB parameters, where communicating via the first sidelink interface and the second sidelink interface may be based on transmitting the sidelink control message.

In some examples of the method, apparatuses, and non-transitory computer-readable medium described herein, the control message further indicates that the set of multiple per-hop sidelink DRB parameters may be for a UE-to-UE relay operation.

In some examples of the method, apparatuses, and non-transitory computer-readable medium described herein, the control message may be received from a network entity, the source UE, or both.

A method is described. The method may include establishing a wireless connection between the network entity and a source UE and transmitting, via the wireless connection and to the source UE, a first control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE.

An apparatus is described. The apparatus may include a processor, memory coupled with the processor, and instructions stored in the memory. The instructions may be executable by the processor to cause the apparatus to establish a wireless connection between the network entity and a source UE and transmit, via the wireless connection and to the source UE, a first control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE.

Another apparatus is described. The apparatus may include means for establishing a wireless connection between the network entity and a source UE and means for transmitting, via the wireless connection and to the source UE, a first control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE.

A non-transitory computer-readable medium storing code is described. The code may include instructions executable by a processor to establish a wireless connection between the network entity and a source UE and transmit, via the wireless connection and to the source UE, a first control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE.

Some examples of the method, apparatuses, and non-transitory computer-readable medium described herein may further include operations, features, means, or instructions for transmitting, to a relay UE, a second control message indicating one or more sets of per-hop sidelink DRB parameters of the set of multiple per-hop sidelink DRB parameters based on transmitting the first control message to the source UE.

Some examples of the method, apparatuses, and non-transitory computer-readable medium described herein may further include operations, features, means, or instructions for receiving a third control message indicating an E2E QoS profile associated with a first sidelink interface between the source UE and the destination UE, a set of multiple QoS profiles associated with the set of multiple communication hops between the source UE and the destination UE, or both, where the set of E2E sidelink DRB parameters may be based on the E2E QoS profile, and where each of the set of multiple per-hop sidelink DRB parameters may be based on a respective quality service profile of the set of multiple QoS profiles.

Some examples of the method, apparatuses, and non-transitory computer-readable medium described herein may further include operations, features, means, or instructions for receiving, via the third control message, an indication of a quantity of communication hops of the set of multiple communication hops between the source UE and the destination UE, where the set of multiple per-hop sidelink DRB parameters may be further based on the quantity of communication hops of the set of multiple communication hops.

Some examples of the method, apparatuses, and non-transitory computer-readable medium described herein may further include operations, features, means, or instructions for transmitting, based on the second control message, an indication of a subset of the set of multiple QoS profiles, the subset of the set of multiple QoS profiles being associated with a subset of the set of multiple communication hops, where the subset of the set of multiple communication hops may be subsequent to a first communication hop between the source UE and the relay UE.

In some examples of the method, apparatuses, and non-transitory computer-readable medium described herein, the first control message and the second control message further indicate that the set of multiple per-hop sidelink DRB parameters may be for a UE-to-UE relay operation.

### BRIEF DESCRIPTION OF THE DRAWINGS

FIG. 1 shows an example of a wireless communications system that supports enhancements to data radio bearer parameters for UE-to-UE (U2U) relays in accordance with one or more aspects of the present disclosure.

FIG. 2 shows an example of a wireless communications system that supports enhancements to DRB parameters for U2U relays in accordance with one or more aspects of the present disclosure.

FIG. 3 shows an example of a wireless communications system that supports enhancements to DRB parameters for U2U relays in accordance with one or more aspects of the present disclosure.

FIG. 4 shows an example of a process flow that supports enhancements to DRB parameters for U2U relays in accordance with one or more aspects of the present disclosure.

FIG. 5 shows an example of a process flow that supports enhancements to DRB parameters for U2U relays in accordance with one or more aspects of the present disclosure.

FIGS. 6 and 7 show block diagrams of devices that support enhancements to DRB parameters for U2U relays in accordance with one or more aspects of the present disclosure.

FIG. 8 shows a block diagram of a communications manager that supports enhancements to DRB parameters for U2U relays in accordance with one or more aspects of the present disclosure.

FIG. 9 shows a diagram of a system including a device that supports enhancements to DRB parameters for U2U relays in accordance with one or more aspects of the present disclosure.

FIGS. 10 and 11 show block diagrams of devices that support enhancements to DRB parameters for U2U relays in accordance with one or more aspects of the present disclosure.

FIG. 12 shows a block diagram of a communications manager that supports enhancements to DRB parameters for U2U relays in accordance with one or more aspects of the present disclosure.

FIG. 13 shows a diagram of a system including a device that supports enhancements to DRB parameters for U2U relays in accordance with one or more aspects of the present disclosure.

FIGS. 14 through 19 show flowcharts illustrating methods that support enhancements to DRB parameters for U2U relays in accordance with one or more aspects of the present disclosure.

### DETAILED DESCRIPTION

In some wireless communications systems, multiple user equipments (UEs) may support UE-to-UE (U2U) relay communications, such that a source UE may communicate with a destination UE even when such UEs do not share coverage areas (e.g., may not be able to communicate with each other over a direct, single-hop link). In one case, the source UE and the destination UE may implement layer 2 (L2) based U2U relay communications. To facilitate the L2 based U2U relay communications, the source UE and the destination UE may directly communicate control data via an end-to-end (E2E) link, while also utilizing one or more intermediary UEs (e.g., relay UEs) to communicate user data via one or more single hop links. A single hop link (e.g., communication hop) may be referred to as a sidelink (e.g., PC5) connection or interface. For example, a single hop link may be established between the source UE and a relay UE, between the relay UE and a second relay UE, between the relay UE and the destination UE, or the like.

In such cases, however, because there may be more than one relay UE (e.g., multiple communication hops) between the source UE and the destination UE, the network entity may not be able to configure data radio bearer (DRB) parameters for each communication hop. That is, using current techniques, the network entity may be able to configure DRB parameters for a single communication hop (e.g., a single PC5 link). Thus, techniques may be desired to enable the network entity to configure DRB parameters for E2E link and multiple communication hops for L2 based U2U relay communications.

The techniques described herein may enable the network entity to configure, and indicate, E2E sidelink DRB parameters and one or more per-hop sidelink DRB parameters in order to support the L2 based U2U relay operations. For example, the source UE, one or more relay UEs, or both, may transmit a control message (e.g., a radio resource control (RRC) message) indicating E2E quality of service (QOS) parameters between the source UE and the destination UE and further indicate per-hop QoS profiles for each communication hop between the source UE and the destination UE. Based on the E2E QoS profiles and per-hop QoS profiles, the network entity may transmit a control message (e.g., an RRC message) indicating E2E sidelink DRB parameters and one or more per-hop sidelink DRB parameters to the source UE, various relay UEs, or both. Further, the source UE may forward such E2E sidelink DRB parameters, one or more per-hop sidelink DRB parameters, or both to the destination UE and various relay UEs within the U2U relay system, thereby providing each UE with respective DRB parameters for use in the U2U relay communications.

By enabling the network entity to configure DRB parameters for more than one communication hop, the UEs in the U2U relay communication system may efficiently receive and implement the sidelink DRB parameters, such that the source UE may communicate user data to the destination UE via one or more relay UEs. As such, the UEs may experience improved coordination and a more efficient utilization of communication resources.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to enhancements to DRB parameters for U2U relays.

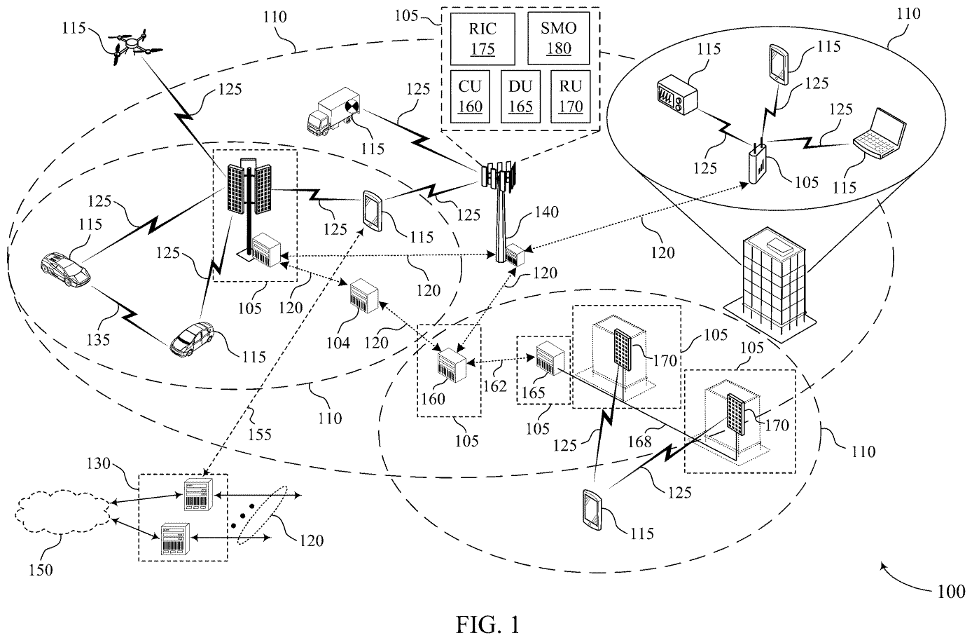

FIG. 1 shows an example of a wireless communications system 100 that supports enhancements to DRB parameters for U2U relays in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support enhancements to DRB parameters for U2U relays as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

In some wireless communications systems, multiple UEs 115 may support U2U relay communications, such that a source UE 115 may be able to communicate with a destination UE 115 even when such UEs 115 do not share coverage areas (e.g., may not be able to communicate with each other over a direct, single-hop link). In one case, the source UE 115 and the destination UE 115 may implement layer 3 (L3) based U2U relay communications. In such cases, the source UE 115 and the destination UE 115 may communicate both user data and control data one or more single hop links. A single hop link (e.g., communication hop) may be referred to as a sidelink (e.g., PC5) connection or interface. For example, a single hop link may be established between the source UE 115 and a relay UE 115, between the relay UE 115 and a second relay UE 115, between the relay UE 115 and the destination UE 115, or the like. That is, in L3 based U2U relay communications, each communication hop between the source UE 115 and the destination UE 115 may include respective L1, L2, and L3 connections for both the user plane and control plane.

For example, the source UE 115 and a relay UE 115 may establish L1, L2, and L3 links of a control plane, where such links may include a PC5-S link, a PC5-RRC link, a packet data convergence protocol (PDCP) link, a sidelink relay adaptation protocol (SRAP) link, a radio link control (RLC) link, a MAC link, and a physical (PHY) link. Further, the source UE 115 and the relay UE 115 may establish L1, L2, and L3 links of a user plane, where such links may include an internet protocol (IP) or non-IP link, a service data application protocol (SDAP) link, a PDCP link, a RLC link, a MAC link, and a PHY link.

Similarly, as part of the L3 based U2U relay communications, the relay UE 115 and the destination UE 115 may establish L1, L2, and L3 links of a control plane, where such links may include a PC5-S link, a PC5-RRC link, a RLC link, a MAC link, and a PHY link. Further, the relay UE 115 and the destination UE 115 may establish L1, L2, and L3 links of a user plane, where such links may include IP or non-IP links, a SDAP links, a PDCP link, a RLC link, a MAC link, a PHY link.

In another case, the source UE 115 and the destination UE 115 may implement L2 based U2U relay communications. To facilitate such L2 based U2U relay communications, the source UE 115 and the destination UE 115 may directly communicate control data via one or more E2E link, while also utilizing one or more intermediary UEs 115 (e.g., relay UEs 115) to communicate user data via one or more individual communication hop links. In such cases, however, because there may be more than one relay UE 115 (e.g., more than one communication hop) between the source UE 115 and the destination UE 115, the network entity 105 may not be able to configure DRB parameters for each communication hop. That is, using current techniques, the network entity 105 may be able to configure DRB parameters for a single communication hop (e.g., a single PC5user plane connection). Thus, techniques may be desired to enable the network entity 105 to configure DRB parameters for multiple communication hops for L2 based U2U relay communications.

The techniques described herein may enable the network entity 105 to configure, and indicate, E2E sidelink DRB parameters and multiple per-hop sidelink DRB parameters in order to support the L2 based U2U relay operations. For example, the source UE 115, one or more relay UEs 115, or both, may transmit a control message (e.g., a RRC message) indicating E2E quality of service (QOS) parameters between the source UE 115 and the destination UE 115 and further indicate per-hop QoS profiles for each communication hop between the source UE 115 and the destination UE 115. Based on the E2E QOS profiles and per-hop QoS profiles, the network entity 105 may transmit a control message (e.g., an RRC message) indicating E2E sidelink DRB parameters and multiple per-hop sidelink DRB parameters to the source UE 115, various relay UEs 115, or both. Further, the source UE 115 may forward such E2E sidelink DRB parameters, multiple per-hop sidelink DRB parameters, or both to the destination UE 115 and various relay UEs 115 within the U2U relay system, thereby providing each UE 115 with respective DRB parameters for use in the U2U relay communications.

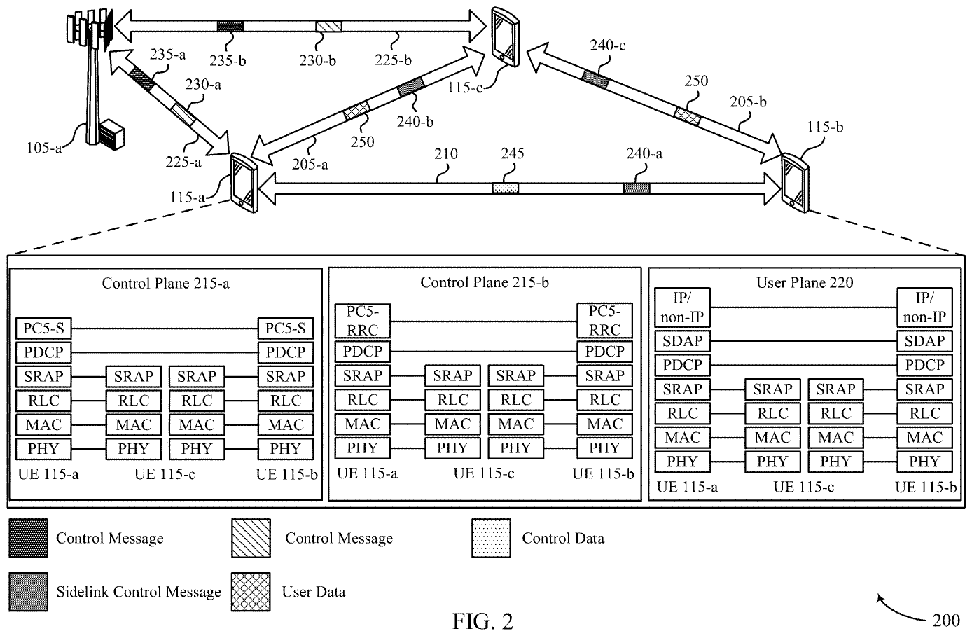

FIG. 2 shows an example of a wireless communications system 200 that supports enhancements to DRB parameters for U2U relays in accordance with one or more aspects of the present disclosure. Aspects, the wireless communications system 200 may implement, or be implemented by, aspects of wireless communications system 100 with reference to FIG. 1. For example, the wireless communications system 200 may include a network entity 105-a, a UE 115-a, a UE 115-b, and a UE 115-c, which may be examples of corresponding devices as described herein. The techniques described in the context of the wireless communications system 200 may enable the network entity 105-a to configure sidelink DRB parameters for L2 based U2U relay communications.

In some cases, the UEs 115 may support U2U relay communications. Such U2U relay communications may enable the UE 115-a to communicate with the UE 115-b via the UE 115-c. In such cases, the UE 115-a may be referred to as the source UE, where the UE 115-a may be the originator of the relayed traffic. Further, the UE 115-b may be referred to as the destination UE, where the UE 115-b may be the destination of the relayed traffic. The UE 115-c may be referred to as the relay UE, where the UE 115-c may relay traffic between the UE 115-a (e.g., source UE) and the UE 115-b (e.g., destination UE).

In some cases, the UE 115-a and the UE 115-b may communicate via a single-hop relay system. Such single-hop relay systems may include a single relay UE (e.g., the UE 115-c) to relay traffic between the UE 115-a and the UE 115-b.

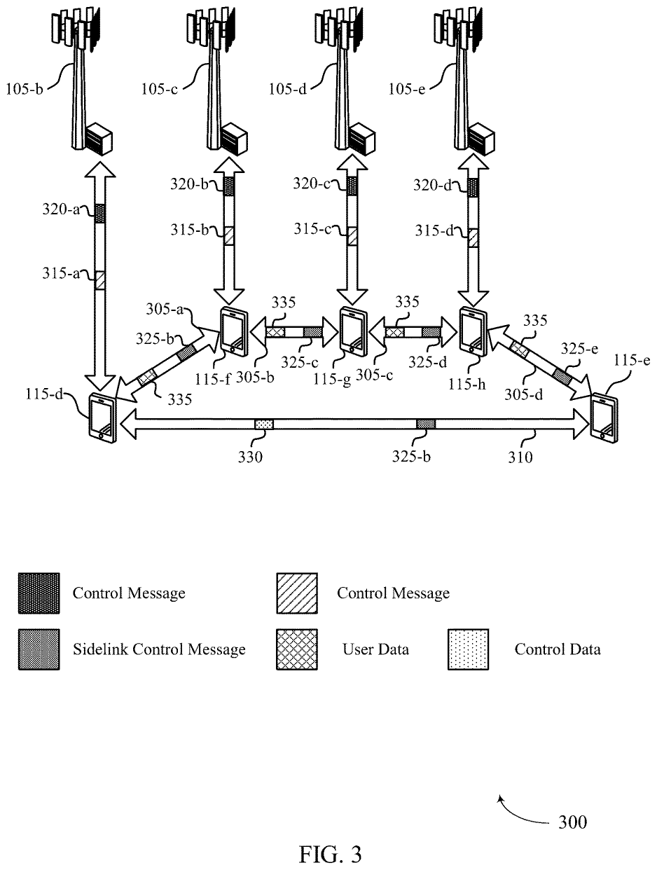

Alternatively, the UE 115-a and the UE 115-b may communicate via a multi-hop relay system (as illustrated in FIG. 3), where such multi-hop relay systems may include multiple relay UEs to relay traffic between the UE 115-a and the UE 115-b. Such multi-hop relay systems may extend, or otherwise expand, 5G or sidelink coverage via the one or more relay UEs. Further, to support such U2U relay communications, the UE 115-a may establish a single hop link 205-a with the UE 115-c, while the UE 115-c may establish a single hop link 205-b with the UE 115-b. Each single hop links 205 may refer to a direct wireless link (e.g., sidelink interface or PC5connection) between relay UEs and remote UEs (e.g., source and destination UEs).

In some cases, the UE 115-a and the UE 115-b may support L2 based U2U relay communications. In such cases, the UE 115-a may establish an E2E link 210 with the UE 115-b, where the E2E link 210 may refer to a link (e.g., connection) between two remote UEs (e.g., between source and destination UEs). The E2E link 210 may be transparent, or otherwise not known, to the UE 115-c. Such L2 based U2U relay communications may enable the UE 115-a to communicate control data 245 to the UE 115-b via the E2E link 210, while also communicating user data 250 to the UE 115-b via UE 115-c using the single hop links 205.

The E2E link 210 may include one or more E2E links of control planes 215 and a user plane 220. For example, as part of the E2E link 210, the UE 115-a and the UE 115-b may establish a PC5-S E2E link of the control plane 215-a (e.g., control plane from the perspective of PC5-s layer) and may also establish a PC5-RRC E2E link of the control plane 215-b (e.g., control plane from the perspective of RRC messaging).

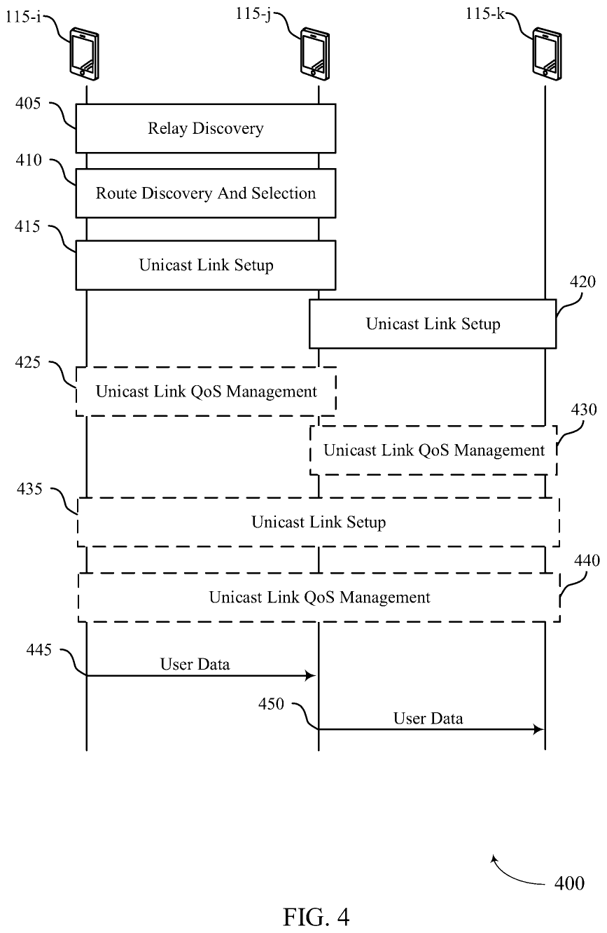

Additionally, in the control planes 215, the UE 115-a and the UE 115-b may establish a PDCP E2E link. Further, the UE 115-a and the UE 115-b may establish one or more E2E links of the user plane 220, where such E2E links may include an IP/non-IP E2E link, a SDAP E2E link, and a PDCP E2E link. In this way, the UE 115-c and the UE 115-b may communicate control data via the E2E link 210, where the E2E link 210 may include one or more E2E links of the control planes 215 and the user plane 220. Such establishment of links may be further described herein with reference to FIG. 4.

Each single hope link 205 may include one or more control plane 215 connections (e.g., PC5connections) between remote UEs and relay UEs. As an illustrative example, the single hop link 205-a (e.g., PC5connection) may include a SRAP link, a RLC link, a MAC link, and a PHY link between the UE 115-a and the UE 115-c, while the single hop link 205-b may include a SRAP link, a RLC link, a MAC link, and a PHY link between the UE 115-c and the UE 115-b. Similarly, each single hop link 205 may include one or more user plane 220 connections (e.g., PC5 connections) between remote UEs and relay UEs. As an illustrative example, the single hop link 205-a may include a SRAP link, a RLC link, a MAC link, and a PHY link between the UE 115-a and the UE 115-c, while the single hop link 205-b may include a SRAP link, a RLC link, a MAC link, and a PHY link between the UE 115-c and the UE 115-b.

In some cases, the UEs 115 may determine PC5QoS profiles of the respective PC5links (e.g., single hop links 205 and the E2E link 210). The PC5QoS profiles may include PC5 QoS profiles, such as a PC5quality index (PQI), PC5flow bit rates, PC5link aggregated bit rates, a range of the links, default values of the links, or a combination thereof. A PQI may be a special 5G quality indicator (5Q1) that is used as a reference to PC5QoS characteristics. For example, the PQI of the PC5QoS profile may indicate a resource type of a PC5link (e.g., such as guaranteed bit rate (GBR), delay critical GBR, or non-GBR), a priority level of the PC5link, a packet delay budget (PDB) of the PC5link, a packet error rate (PER) of the PC5link, an average window parameter (e.g., for GBR and delay critical GBR resource types), a threshold (e.g., maximum) data burst volume (e.g., for GBR and delay critical GBR resource types), or a combination thereof. As described herein, each single hop link 205 and the E2E link 210 may include respective PC5QoS profiles, such that each respective link may be established based on the respective PC5 QoS profile.

In some cases, the network entity 105-a may control, or otherwise configure, the direct PC5communications between the UE 115-a and the UE 115-c. For example, if the UE 115-a is operating in an active mode (e.g., RRC_CONNECTED mode), then the UE 115-a may transmit sidelink UE information to the network entity 105-a in order to request or release sidelink resources and report QoS information of the single hop link 205-a between the UE 115-a and the UE 115-c. In response, the network entity 105-a may provide an RRC reconfiguration message (e.g., RRCReconfiguration) to the UE 115-a in order to provide the UE 115-a with a dedicated sidelink configuration. In such cases, the RRC reconfiguration message may include sidelink DRB parameters (e.g., a sidelink DRB configuration) for the sidelink communications between the UE 115-a and the UE 115-c. In some cases, the network entity 105-a may provide, via system information (e.g., such as a system information block (SIB), common sidelink configurations to the UE 115-a in cases when the UE 115-a is operating in an inactive mode (e.g., RRC_IDLE mode or RRC_INACTIVE mode) for sidelink communications between the UE 115-a and the UE 115-c.

In response, the UE 115-a may establish the single hop link 205-a between the UE 115-a and the UE 115-c according to the received sidelink DRB parameters from the network entity 105-a and provide the sidelink DRB parameters to the UE 115-c using a RRC reconfiguration sidelink message (e.g., RRCReconfigurationSidelink). In response to receiving the RRC reconfiguration sidelink message, the UE 115-c may transmit a RRC reconfiguration complete sidelink message (e.g., RRCReconfigurationCompleteSidelink) in order to acknowledge that the UE 115-c has applied the sidelink DRB parameters.

In U2U relay communications, there may be more than one single hop link 205 between the UE 115-a and the UE 115-b. That is, using L2 based U2U relay communications may lead the UE 115-a and the UE 115-b to use a set of E2E sidelink DRB parameters (e.g., E2E SDAP and PDCP configurations) in order to establish, or otherwise configure, the E2E link 210 between the UE 115-a and the UE 115-b. Further, using L2 based U2U relay communications may lead to the use of multiple per-hop sidelink DRB parameters (e.g., SRAP, RLC, MAC configurations for each single hop link 205) in order to establish, or otherwise configure, each single hop link 205 between the two peer UEs (source UE to relay UE, relay UE to destination UE, relay UE to relay UE, or the like).

Using current techniques, however, the network entity 105-a may support configuring up to one single hop link 205 for PC5 communications. Further, using current techniques, the network entity 105-a may provide available sidelink DRB parameters for the PC5communication based on received QoS profiles for a single PC5link. However, for L2 based U2U relay communications, the network entity 105-a may not be able to differentiate between the QoS profiles for the E2E link 210 and QoS profiles for each single hop link 205, leading to the network entity 105-a being unable generate and provide sidelink DRB configurations for each single hop link 205 and the E2E link 210. Thus, techniques may be desired to enable the network entity 105-a to configure DRB parameters for the E2E link 210 and multiple single hop links 205 for L2 based U2U relay communications.

The techniques described herein may enable the network entity 105-a to provide sidelink DRB parameters (e.g., configurations) for L2 based U2U relay communications. In one example, the UE 115-a (e.g., remote UE or source UE), the UE 115-c (e.g., relay UE), or both may report an E2E QoS profile for the E2E link 210, multiple per-hop QoS profiles for each communication hop between the UE 115-a and the UE 115-b, or both to the network entity 105-a (e.g., the respective serving gNBs). In response, the network entity 105-a (e.g., respective serving gNBs) may provide corresponding sidelink DRB parameters to the UE 115-a, the UE 115-c, or both. Such techniques may be further described herein with reference to FIG. 2.

In another example, the UE 115-a (e.g., remote UE or source UE) may report the E2E QoS profile and a quantity of communication hops (e.g., hop numbers) to the network entity 105-a. In response, the network entity 105-a may provide a set of E2E sidelink DRB parameters and multiple per-hop sidelink parameters based on the E2E QoS profile and the quantity of communication hops. Such techniques may be further described herein with reference to FIG. 2.

In another example, the UE 115-a (e.g., remote UE or source UE) may report a respective QoS profile for each single hop link 205 and a quantity of communication hops (e.g., hop numbers) to the network entity 105-a. In response, the network entity 105-a may split the QoS profiles into a QoS profile for the single hop link 205-a (e.g., current single hop link) and a set of QoS profiles for the remaining single hop links 205 (e.g., the single hop link 205-b). Based on splitting the QoS profiles into the current QoS profile and remaining QoS profiles, the network entity 105-a may provide the UE 115-a with the QoS profiles for the remaining hops and sidelink DRB parameters for the single hop link 205-a. The UE 115-a may proceed to transmit the QoS profiles for the remaining hops to the UE 115-c, where the UE 115-c may communicate with a respective serving network entity 105 to receive the sidelink DRB parameters for the current single hop link. Such techniques may be further described herein with reference to FIG. 3.

In some implementations, the UE 115-a (e.g., remote UE or source UE), the UE 115-c (e.g., relay UE), or both may report an E2E QoS profile for the E2E link 210, multiple per-hop QoS profiles for each communication hop between the UE 115-a and the UE 115-b, or both to the network entity 105-a (e.g., the respective serving gNBs).

For example, the UE 115-a may transmit, to the network entity 105-a (e.g., serving gNB) via a Uu interface 225-a, a control message 230-a (e.g., such as a Sidelink UEInformationNR RRC message) that indicates both the E2E QoS profile for the E2E link 210 and a first per-hop QoS profile for the single hop link 205-a between the UE 115-a and the UE 115-c.

Based on receiving the control message 230-a, the network entity 105-a may provide a set of E2E sidelink DRB parameters (e.g., SDAP and PDCP DRB configurations) and provide a first set of per-hop sidelink DRB parameters for the single hop link 205-a (e.g., SRAP, RLC, MAC, and logical channel DRB configurations) via a control message 235-a (e.g., such as an RRC message). Additionally, in some examples, the network entity 105-a may indicate, via the control message 235-a that the set of E2E sidelink DRB parameters and the first set of per-hop sidelink DRB parameters are for U2U relay communications (e.g., for a U2U relay operation). Such an indication may be an information element as part of the control message 235-a, a flag, or both.

That is, the network entity 105-a may configure the set of E2E sidelink DRB parameters based on the E2E QoS profile and also configure the first set of per-hop sidelink DRB parameters based on the first per-hop QoS profile for the single hop link 205-a. In such examples, the set of E2E sidelink DRB parameters may include DRBs for the E2E PDCP links and E2E SDAP links of the control planes 215 and the user plane 220. Similarly, the first set of per-hop sidelink DRB parameters may include DRBs for each of the SRAP links, RLC links, MAC links, and PHY links of the control planes 215 and the user plane 220.

As an illustrative example, the network entity 105-a may configure the first set of per-hop sidelink DRB parameters for the single hop link 205-a based on the first QoS profile for the single hop link 205-a, where the first set of per-hop sidelink DRB parameters includes respective DRBs for the SRAP links, the RLC links, the MAC links, the PHY links, or any combination thereof for the user plane 220 and the control planes 215 of the single hop link 205-a between the UE 115-a and the UE 115-c.

In response to receiving the control message 235-a, the UE 115-a may provide the set of E2E sidelink DRB parameters to the UE 115-b via the sidelink control message 240-a (e.g., such as an RRCReconfigurationSidelink message) according to the received set of E2E sidelink DRB parameters from the network entity 105-a. That is, in response to receiving the set of E2E sidelink DRB parameters, the UE 115-a may apply the set of E2E DRB parameters to establish the E2E link 210 and transmit, via the sidelink control message 240-a, the set of E2E DRB parameters via the E2E link 210 established based on the set of E2E DRB parameters. In this way, the UE 115-b may have an indication of the E2E link 210 and receive control data 245 via the E2E link 210.

Additionally, in some examples, the UE 115-a may provide the first set of per-hop sidelink DRB parameters to the UE 115-c, the UE 115-b, or both via the sidelink control messages 240 (e.g., RRCReconfigurationSidelink message) according to the received set of E2E sidelink DRB parameters, the first set of per-hop sidelink DRB parameters, or both. For example, the UE 115-a may transmit, to the UE 115-c, a sidelink control message 240-b (e.g., RRCReconfigurationSidelink message) that includes an indication of the first set of per-hop sidelink DRB parameters, such that the UE 115-c may establish, or otherwise be aware of, the sidelink DRBs of the single hop link 205-a.

In this way, the UE 115-a may indicate the respective sidelink DRB parameters to the UE 115-b and the UE 115-c for the E2E link 210 and the single hop link 205-a. As such, the UE 115-c may transmit the user data 250 to the UE 115-c via the single hop link 205-a, where the single hop link 205-a may be established based on the first set of per-hop sidelink DRB parameters. Additionally, the UE 115-a may communicate the control data 245 to the UE 115-b via the E2E link 210, where the E2E link 210 may be established based on the E2E per-hop sidelink DRB parameters.

Further, the UE 115-c may transmit, via a Uu interface 225-b to the network entity 105-a (e.g., or a respective serving gNB), a control message 230-b (e.g., such as via a SidelinkUEInformationNR element of an RRC message) that includes an indication of one or more per-hop QoS profiles for the single hop link 205-a, the single hop link 205-b, or both. As described herein, it should be understood that a network entity serving the UE 115-c (or various other relay UEs between the UE 115-a and the UE 115-b) may be different from, or the same as, the network entity 105-a serving the UE 115-a. That is, the UE 115-c may transmit the control message 230-b to a respective serving network entity different from the network entity 105-a, and receive a control message 235-b, from the respective serving network entity. Alternatively, the UE 115-a and the UE 115-c may share, or otherwise communicate, with the same serving network entity 105-a.

The one or more per-hop QoS profiles may include each QoS profile on two PC5communication hops or the QoS profile for the next communication hop. That is, the UE 115-c may provide, via the control message 230-b, an indication of a first QoS profile for the single hop link 205-a and a second QoS profile for the single hop link 205-b. Alternatively, the UE 115-c may provide, via the control message 230-b, the second QoS profile for the single hop link 205-b (e.g., next communication hop). It should be understood that any relay UE between the UE 115-a and the UE 115-b may provide respective QoS profiles for associated communications hops to respective serving network entities.

In response to receiving the control message 230-b, the network entity 105-a (e.g., or a respective serving network entity associated with the UE 115-c) may provide one or more per-hop sidelink DRB parameters (e.g., DRB parameters for the SRAP links, RLC links, MAC links, logical channel links, or the like) via the control message 235-b (e.g., such as an RRC message) to the UE 115-c. Additionally, in some examples, the network entity 105-a may indicate, via the control message 235-b that the one or more per-hop sidelink DRB parameters are for U2U relay communications (e.g., for a U2U relay operation). Such an indication may be an information element as part of the control message 235-b, a flag, or both.

As an illustrative example, the UE 115-c may receive, via the control message 235-b, a first set of per-hop sidelink DRB parameters for the single hop link 205-a, where the first set of per-hop sidelink DRB parameters is based on a first per-hop QoS profile for the single hop link 205-a. Similarly, the UE 115-c may receive, via the control message 235-b, a second set of per-hop sidelink DRB parameters for the single hop link 205-b, where the second set of per-hop sidelink DRB parameters may be based on a second per-hop QoS profile for the single hop link 205-b.

In this way, the UE 115-c may have an indication of the per-hop sidelink DRB parameters for the single hop link 205-a and the single hop link 205-b. The UE 115-c may establish the single hop link 205-a, the single hop link 205-b, or both based on the respective sidelink DRB parameters and relay the user data 250 to the UE 115-b from the UE 115-a. As described herein, multiple relay UEs between the UE 115-a and the UE 115-b may be able to provide such per-hop QoS profiles to respective serving network entities and receive, from the respective serving network entities, sidelink DRB parameters for the respective communication hops.

In some other implementations, the network entity 105-a (e.g., serving gNB) may transmit the set of E2E sidelink parameters and multiple per-hop sidelink parameters to the UE 115-a. For example, the UE 115-a may transmit, via the control message 230-a, the E2E QoS profile for the E2E link 210 and a quantity of communication hops between the UE 115-a and the UE 115-b (e.g., quantity of single hop links 205) to the network entity 105-a (e.g., serving gNB). In response, the network entity 105-a may transmit, via the control message 235-a, an indication of the set of E2E sidelink DRB parameters and also indicate multiple per-hop sidelink DRB parameters to the UE 115-a, where such multiple per-hop sidelink DRB parameters may include respective sets of DRB parameters for each single hop link between the UE 115-a and the UE 115-b.

In such implementations, the UE 115-a may provide the set of E2E sidelink DRB parameters, the multiple per-hop sidelink DRB parameters, or both to the UE 115-b via the sidelink control message 240-a and provide the multiple per-hop sidelink DRB parameters to the UE 115-c according to the received DRB parameters from the network entity 105-a. That is, the UE 115-a may establish the E2E link 210 based on the set of E2E sidelink DRB parameters and establish the single hop link 205-a based on a first set of per-hop sidelink DRB parameters associated with the single hop link 205-a. In this way, the UE 115-a may provide the respective sidelink DRB parameters to the UE 115-c and the UE 115-b in order to facilitate L2 based U2U relay communications.

Further, based on receiving the sidelink control message 240-b, the UE 115-c may provide the multiple per-hop sidelink DRB parameters to a peer UE (e.g., either an additional relay UE or the UE 115-b) via the sidelink control message 240-c (e.g., RRCReconfigurationSidelink message) according to the per-hop sidelink DRB parameters received via the sidelink control message 240-b. That is, the UE 115-c may establish the single hop link 205-b based on the respective per-hop sidelink DRB parameters associated with the single hop link 205-b and transmit an indication of the multiple per-hop sidelink DRB parameters to the peer UE based on establishing the single hop link 205-b.

By enabling the network entity 105-a to configure DRB parameters for more than one communication hop, the UEs 115 in the U2U relay communication system may efficiently receive and implement the sidelink DRB parameters, such that the UE 115-a may communicate user data 250 to the destination UE 115-b. As such, the UEs 115 may experience improved coordination, a decrease in communication overhead, and implement more efficient utilization of communication resources.

FIG. 3 shows an example of a wireless communications system 300 that supports enhancements to DRB parameters for U2U relays in accordance with one or more aspects of the present disclosure. Aspects of the wireless communications system 300 may implement, or be implemented by, aspects of the wireless communications system 100 and the wireless communications system 200 as described herein with reference to FIGS. 1 and 2. For example, the wireless communications system 300 may include a network entity 105-b, a network entity 105-c, a network entity 105-d, and a network entity 105-d, which may be examples of corresponding network entities as described herein. Further, the wireless communications system 300 may include a UE 115-d, a UE 115-e, a UE 115-f, a UE 115-g, and a UE 115-h, which may be examples of corresponding UEs as described herein. The techniques described in the context of the wireless communications system 300 may enable the UE 115-d to communicate with the UE 115-e via various relay UEs (e.g., the UE 115-f, the UE 115-g, and the UE 115-h) in L2 based U2U relay communications.

In some implementations of the present disclosure, the respective network entities 105 (e.g., serving gNBs) may provide the sidelink DRB parameters for the current hop to the respective UEs 115. For example, if a UE 115 (e.g., a remote UE or the relay UE) obtains the QoS profiles for the various single hop links 305 between the UE 115-d and the UE 115-e, then the UE 115 may report the QoS profiles and quantity of communication hops a respective serving network entity 105.

In response, the respective serving network entity 105 may split the QoS profiles into a QoS profile for the current communication hop and QoS profiles to be used for remaining, or subsequent, communication hops. The serving network entity 105 may provide, to the UE 115, the QoS profiles used for remaining hops.

Additionally, the serving network entity 105 may also provide a first set of per-hop sidelink DRB parameters to the UE 115 for current hop.

The current UE 115 then provides the QoS profiles used for the remaining communication hops to the next UE 115 in the U2U relay (e.g., next relay UE or remote UE), where the next UE 115 may transmit the QoS profiles to the respective serving network entity 105 and receive sidelink DRB parameters for the current hop and QoS profiles for the remaining communication hops. In such examples, if the UE 115 is a source UE, then the serving network entity 105 of the UE 115 may provide the set of E2E sidelink DRB parameters and the set of per-hop sidelink DRB parameters for the current hop to the UE 115. Alternatively, if the UE 115 is a relay UE, then the serving network entity 105 of the UE 115 may provide the set of per-hop sidelink DRB parameters for the current communication hop to the UE 115.

As an illustrative example, the UE 115-d (e.g., source UE) may obtain the QoS profiles for each of the single hop links 305 (e.g., single hop link 305-a, a single hop link 305-b, a single hop link 305-c, and a single hop link 305-d) and an E2E sidelink QoS profile for an E2E link 310. As such, the UE 115-d may transmit a control message 315-a in order to report the per-hop QoS profiles, the E2E QoS profile, the quantity of communication hops (e.g., hop number) between the UE 115-d and the UE 115-e, or a combination thereof to the network entity 105-b, which may be the serving network entity of the UE 115-d.

In response to receiving the control message 315-a, the network entity 105-b may split the QoS profiles for each of the single hop links 305 into a current QoS profile for the single hop link 305-a (e.g., current communication hop) and remaining QoS profiles (e.g., a subset of the QoS profiles) for the remaining single hop links 305, such as QoS profiles associated with the single hop link 305-b, the single hop link 305-c, and the single hop link 305-d. In some examples, the network entity 105-b may split the QoS profiles based on the quantity of communication hops (e.g., hop number) indicated in the control message 315-a.

Based on splitting the QoS profiles, the network entity 105-b may generate, or otherwise configure, a first set of sidelink DRB parameters for the single hop link 305-a based on the current QoS profile for the single hop link 305-a. Further, because the UE 115-d is a source UE and provides the E2E QoS profile for the E2E link 310, the network entity 105-b may configure the set of E2E sidelink DRB parameters for the E2E link 310. The network entity 105-b may transmit a control message 320-a (e.g., RRC message), to the UE 115-d, indicating the first set of sidelink DRB parameters for the single hop link 305-a, the set of E2E sidelink DRB parameters for the E2E link 310, the remaining QoS profiles for the single hop link 305-b, the single hop link 305-c, and the single hop link 305-d, or a combination thereof.

Based on receiving control message 320-a, the UE 115-d may transmit, via the E2E link 310, a sidelink control message 325-b in order to indicate the set of E2E sidelink DRB parameters to the UE 115-e. In this way, the UE 115-d may transit control data 330 to the UE 115-e via the E2E link 310. Further, based on receiving the control message 320-a, the UE 115-d may transmit, to the UE 115-f via the single hop link 305-a, a sidelink control message 325-b indicating the remaining QoS profiles for the single hop link 305-b, the single hop link 305-c, and the single hop link 305-d, where the UE 115-d may establish the single hop link 305-a based on the first set of sidelink DRB parameters for the single hop link 305-a. In some examples, the UE 115-d may also indicate the first set of sidelink DRB parameters to the UE 115-f via the sidelink control message 325-b.

In response to receiving sidelink control message 325-b, the UE 115-f may transmit, to the network entity 105-c, a control message 315-b indicating the remaining QoS profiles for the single hop link 305-b, the single hop link 305-c, and the single hop link 305-d, indicating a quantity of remaining communication hops, or both. In such examples, the network entity 105-c may be the serving network entity for the UE 115-f.

In response to receiving the control message 315-b, the network entity 105-c may split the QoS profiles into a current QoS profile for the single hop link 305-b and remaining QoS profiles for the single hop link 305-c and the single hop link 305-d.

Based on splitting the QoS profiles, the network entity 105-c may generate a second set of per-hop sidelink DRB parameters for the single hop link 305-b based on the current QoS profile for the single hop link 305-b.

The network entity 105-c may transmit a control message 320-b indicating the second set of per-hop sidelink DRB parameters for the single hop link 305-b, the remaining QoS profiles for the single hop link 305-c and the single hop link 305-d, or both. In response to receiving the control message 320-b, the UE 115-f may configure, or otherwise establish, the single hop link 305-b based on the second set of per-hop sidelink DRB parameters. Further, the UE 115-f may transmit, to the UE 115-g via the single hop link 305-b, a sidelink control message 325-c indicating the remaining QoS profiles for the single hop link 305-c and the single hop link 305-d. In some examples, the UE 115-f may also indicate, via the sidelink control message 325-c, the second set of per-hop sidelink DRB parameters.

In response to receiving sidelink control message 325-c, the UE 115-g may transmit, to the network entity 105-d, a control message 315-c indicating the remaining QoS profiles for the single hop link 305-c and the single hop link 305-d, indicating a quantity of remaining communication hops, or both. In such examples, the network entity 105-d may be the serving network entity for the UE 115-g.

In response to receiving the control message 315-c, the network entity 105-d may split the QoS profiles into a current QoS profile for the single hop link 305-c and remaining QoS profiles for the single hop link 305-d. Based on splitting the QoS profiles, the network entity 105-c may generate a third set of per-hop sidelink DRB parameters for the single hop link 305-c based on the current QoS profile for the single hop link 305-c.

The network entity 105-c may transmit a control message 320-c indicating the third set of per-hop sidelink DRB parameters for the single hop link 305-c, the remaining QoS profiles for the single hop link 305-d, or both. In response to receiving the control message 320-c, the UE 115-g may configure, or otherwise establish, the single hop link 305-c based on the third set of per-hop sidelink DRB parameters.

Further, the UE 115-g may transmit, to the UE 115-h via the single hop link 305-c, a sidelink control message 325-d indicating the remaining QoS profiles for the single hop link 305-d. In some examples, the UE 115-g may also indicate, via the sidelink control message 325-d, the third set of per-hop sidelink DRB parameters.

In response to receiving sidelink control message 325-d, the UE 115-h may transmit, to the network entity 105-e, a control message 315-d indicating the remaining QoS profiles for the single hop link 305-d, indicating a quantity of remaining communication hops, or both. In such examples, the network entity 105-e may be the serving network entity for the UE 115-h.

In response to receiving the control message 315-d, the network entity 105-e may generate a third set of per-hop sidelink DRB parameters for the single hop link 305-d based on the QoS profile for the single hop link 305-d. The network entity 105-e may not split the QoS profiles due to a single communication hop remaining between the UE 115-h and the UE 115-e.

The network entity 105-e may transmit a control message 320-d indicating the third set of per-hop sidelink DRB parameters for the single hop link 305-d. In response to receiving the control message 320-d, the UE 115-h may configure, or otherwise establish, the single hop link 305-d based on the third set of per-hop sidelink DRB parameters. In some examples, the UE 115-g may indicate, via a sidelink control message 325-e, the second set of per-hop sidelink DRB parameters.

In this way, the UE 115-d may be able to communicate user data 335 via one or more relay UEs 115, resulting in an expanded coverage area, improved coordination between devices, and a more efficient utilization of communication resources.

FIG. 4 shows an example of a process flow 400 that supports enhancements to DRB parameters for U2U relays in accordance with one or more aspects of the present disclosure. Aspects of the process flow 400 may implement, or be implemented by, aspects of the wireless communications system 100, the wireless communications system 200, and the wireless communications system 300, as described herein with reference to FIGS. 1 through 3. For example, the process flow 400 may include a UE 115-i, a UE 115-j, and a UE 115-k, which may be examples of corresponding devices as described herein. The techniques described in the context of the process flow 400 may enable the UE 115-i (e.g., source UE) to communicate with the UE 115-k (e.g., destination UE) via the UE 115-j (e.g., relay UE) as part of U2U relay communications. For example, the techniques described in the context of the process flow 400 may enable the UEs 115 to perform relay connection setup.

At 405, the UE 115-i may perform a relay discovery procedure to identify one or more relay UEs 115. In some examples, the UE 115-i may identify the UE 115-j based on performing the relay discovery procedure. At 410, the UE 115-i and the UE 115-j may perform a route discovery and selection procedure in order to identify and select a route for relaying data traffic from the UE 115-i to the UE 115-k via the UE 115-j. At 415, the UE 115-i and the UE 115-j may perform a unicast link setup procedure in order to establish a unicast PC5(e.g., sidelink) connection. Similarly, at 420, the UE 115-j and the UE 115-k may perform a unicast link setup procedure in order to establish a unicast PC5connection.

In some examples, at 425, if the UEs 115 support L3 based U2U relay communications, the UE 115-i and the UE 115-j may perform a unicast link QoS management procedure in order to manage, or otherwise identify, the QoS profiles of the unicast link between the UE 115-i and the UE 115-j. Similarly, at 430, if the UEs 115 support L3 based U2U relay communications, the UE 115-j and the UE 115-k may perform a unicast link QoS management procedure in order to manage, or otherwise identify, the QoS profiles of the unicast link between the UE 115-j and the UE 115-k.

Alternatively, at 435, if the UEs 115 support L2 based U2U relay communications, the UE 115-i and the UE 115-k may perform a unicast link setup procedure in order to establish a unicast E2E link between the UE 115-i and the UE 115-k. Similarly, at 440, the UE 115-i and the UE 115-k may perform a unicast link QoS management procedure to identify, or otherwise manage, E2E QOS profiles for the E2E link.

In accordance with the techniques described herein, the UE 115-i, the UE 115-j, or both may report such QoS profiles to a network entity 105 in order to receive various E2E or per-hop sidelink DRB parameters for use in relaying traffic from the UE 115-i to the UE 115-k. At 445, the UE 115-i may transmit user data to the UE 115-j, where, at 450, the UE 115-j may relay the user data to the UE 115-k. In this way, the UEs 115 may perform L2 based U2U relay communications.

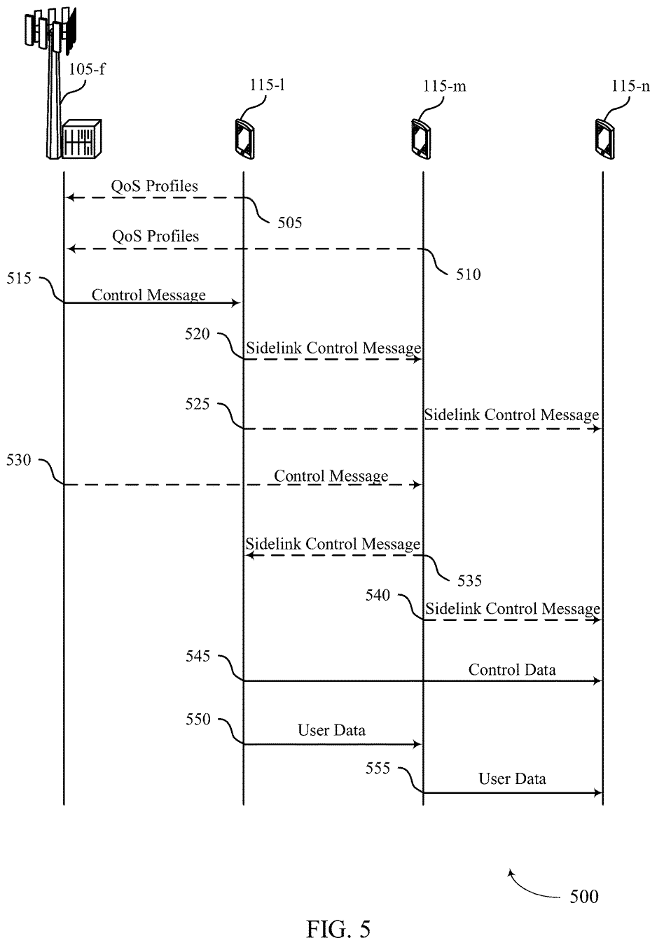

FIG. 5 shows an example of a process flow 500 that supports enhancements to DRB parameters for U2U relays in accordance with one or more aspects of the present disclosure. Aspects of the process flow 500 may implement, or be implemented by, aspects of the wireless communications system 100, the wireless communications system 200, the wireless communications system 300, and the process flow 400 as described herein with reference to FIGS. 1 through 4. For example, the process flow 500 may include a network entity 105-f, a UE 115-1, a UE 115-m, a UE 115-n, which may be examples of corresponding devices as described herein. The techniques described in the context of the process flow 500 may enable the network entity to configure sidelink DRB parameters for L2 based U2U relay communications.

At 505, the UE 115-1 (e.g., source UE) may transmit, to the network entity 105-f, a control message (e.g., such as the control message 230-a and the control message 315-a) that indicates an E2E QoS profile for a first sidelink interface (e.g., such as an E2E link 210 and an E2E link 310) between the UE 115-1 and the UE 115-n (e.g., destination UE), indicates multiple per-hop QoS profiles for multiple communication hops (e.g., such as single hop links 205 and single hop links 305) between the UE 115-1 and the UE 115-n, or both. In some examples, the UE 115-1 may indicate, via the control message, a quantity of communication hops between the UE 115-1 and the UE 115-n.

At 510, the UE 115-m (e.g., relay UE) may transmit, to the network entity 105-f (e.g., serving gNB), a control message (e.g., such as the control message 230-b and the control messages 315) indicating multiple per-hop QoS profiles for the multiple communication hops between the UE 115-1 and the UE 115-m. In some examples, the UE 115-m may also indicate, via the control message, the quantity of communication hops between the UE 115-1 and the UE 115-n. In such examples, the multiple per-hop QoS profiles may include a first QoS profile for a sidelink interface (e.g., single hop link or communication hop) between the UE 115-1 and the UE 115-m and include a second QoS profile for a sidelink interface between the UE 115-m and the UE 115-n.

Alternatively, the UE 115-m may indicate, via the control message, a QoS profile for the sidelink interface between the UE 115-m and the UE 115-n.

At 515, in response to receiving the QoS profiles from the UE 115-1, the network entity 105-f may transmit a control message (e.g., such as the control message 235-a and the control message 320-a) indicating a set of E2E sidelink DRB parameters and multiple per-hop sidelink DRB parameters. In such examples, the set of E2E sidelink DRB parameters may be for a sidelink interface between the UE 115-1 and the UE 115-n, while the multiple per-hop sidelink DRB parameters may be for multiple communication hops (e.g., sidelink interfaces) between the UE 115-1 and the UE 115-n. Further, in some examples, the network entity 105-f may indicate, via the control message, that the set of E2E sidelink DRB parameters and the multiple per-hop sidelink DRB parameters are for a U2U relay operation (e.g., L2 based U2U relay communications.

In some examples, the network entity 105-f may indicate, to the UE 115-1 via the control message, a subset of the multiple QoS profiles, where the subset of the multiple QoS profiles may be associated with a subset of the communication hops between the UE 115-1 and the UE 115-n. That is, the subset of the multiple QoS profiles may be associated with a subset of communication hops that are subsequent to the communication hop between the UE 115-1 and the UE 115-m as described herein with reference to FIG. 3.

At 520, in response to receiving the control message at 515, the UE 115-1 may transmit a sidelink control message indicating the multiple per-hop sidelink DRB parameters to the UE 115-m. In some examples, if the UE 115-1 receives the subset of the multiple QoS profiles via the control message at 515, the UE 115-1 may transmit, or otherwise forward, the subset of the multiple QoS profiles to the UE 115-m.

Additionally, at 525, the UE 115-1 may transmit a sidelink control message indicating the multiple per-hop sidelink DRB parameters, indicating the set of E2E sidelink DRB parameters, or both to the UE 115-n.

In some examples, at 530, the network entity 105-f may transmit a control message (e.g., such as the control message 235-b) to the UE 115-m indicating the multiple per-hop sidelink DRB parameters based on receiving the QoS profiles at 510. In such examples, the network entity 105-f may indicate, via the control message, that the multiple per-hop sidelink DRB parameters may be for the U2U relay operation.

At 535, in some examples, the UE 115-m may transmit a sidelink control message indicating the multiple per-hop sidelink DRB parameters to the UE 115-1 based on receiving the control message at 530. Additionally, at 540, the UE 115-m may transmit a sidelink control message indicating the multiple per-hop sidelink DRB parameters to the UE 115-n based on receiving the control message at 530.

In some examples, if the UE 115-m receives the subset of the multiple QoS profiles from the UE 115-1 at 520, the UE 115-m may transmit the subset of QoS profiles to a serving network entity associated with the UE 115-m and receive a second subset of the multiple QoS profiles, where the second subset of the multiple QoS profiles are associated with future, or subsequent, communication hops. The UE 115-m may transmit, via the sidelink control message at 540, the second subset of the multiple QoS profiles to a second relay UE (e.g., not shown) as described herein with reference to FIG. 3.

At 545, the UE 115-1 may transmit, via a first sidelink interface (e.g., such as the E2E link 210 and the E2E link 310), control data to the UE 115-n in accordance with the set of E2E sidelink DRB parameters.

At 550, the UE 115-1 may transmit, via a second sidelink interface (e.g., such as the single hop link 205-a and the single hop link 305-a), user data to the UE 115-m in accordance with a first set of per-hop sidelink DRB parameters of the multiple per-hop sidelink DRB parameters. In such examples, the user data may be for the UE 115-n.

At 555, based on receiving the user data from the UE 115-1, the UE 115-m may transmit, or otherwise relay, the user data via a third sidelink interface (e.g., such as a single hop link 205-b) in accordance with a second set of per-hop sidelink DRB parameters of the multiple per-hop sidelink DRB parameters. In some examples, if the process flow is a single hop relay system, then the UE 115-m may forward the user data to the UE 115-n (e.g., destination UE). Otherwise, if the process flow 500 is an example of a multi-hop relay system, the UE 115-m may transmit, or otherwise forward, the user data to a second relay UE, where the second relay UE may transmit the user data to an additional relay UE or the UE 115-n. It should be understood that the techniques described herein may apply to any quantity of relay UEs between the UE 115-1 and the UE 115-n.

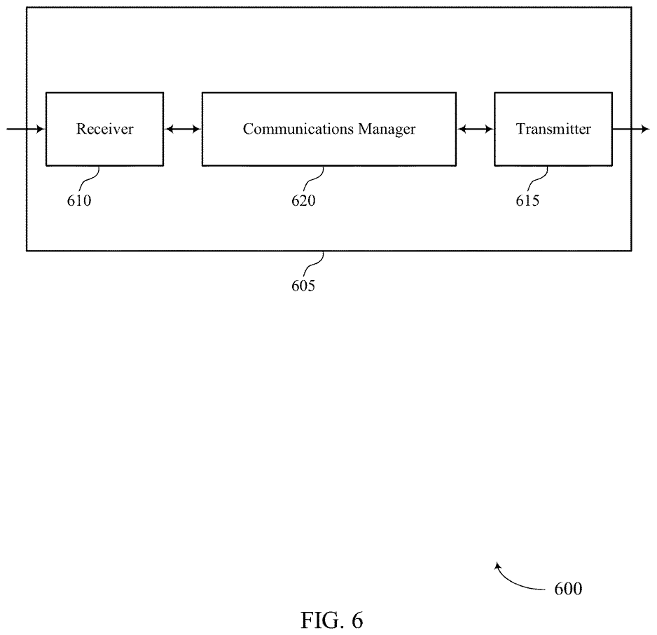

FIG. 6 shows a block diagram 600 of a device 605 that supports enhancements to DRB parameters for U2U relays in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to enhancements to DRB parameters for U2U relays). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to enhancements to DRB parameters for U2U relays). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of enhancements to DRB parameters for U2U relays as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a source UE in accordance with examples as disclosed herein. For example, the communications manager 620 is capable of, configured to, or operable to support a means for receiving a control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE. The communications manager 620 is capable of, configured to, or operable to support a means for transmitting, via a first sidelink interface, control data to the destination UE in accordance with the set of E2E sidelink DRB parameters. The communications manager 620 is capable of, configured to, or operable to support a means for transmitting, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops.

For example, the communications manager 620 is capable of, configured to, or operable to support a means for receiving a control message indicating a set of multiple per-hop sidelink DRB parameters, the set of multiple per-hop sidelink DRB parameters associated with a set of multiple communication hops between a source UE and a destination UE. The communications manager 620 is capable of, configured to, or operable to support a means for receiving user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops. The communications manager 620 is capable of, configured to, or operable to support a means for transmitting the user data via a second sidelink interface in accordance with a second set of per-hop sidelink DRB parameters of the set of multiple per-hop sidelink DRB parameters, the second sidelink interface corresponding to a second communication hop of the set of multiple communication hops.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for a network entity 105 to configure sidelink DRB parameters for multiple communication hops between a source UE and a destination UE and configure sidelink DRB parameters for an E2E link between the source UE and the destination UE, resulting in a more efficient utilization of communication resources.

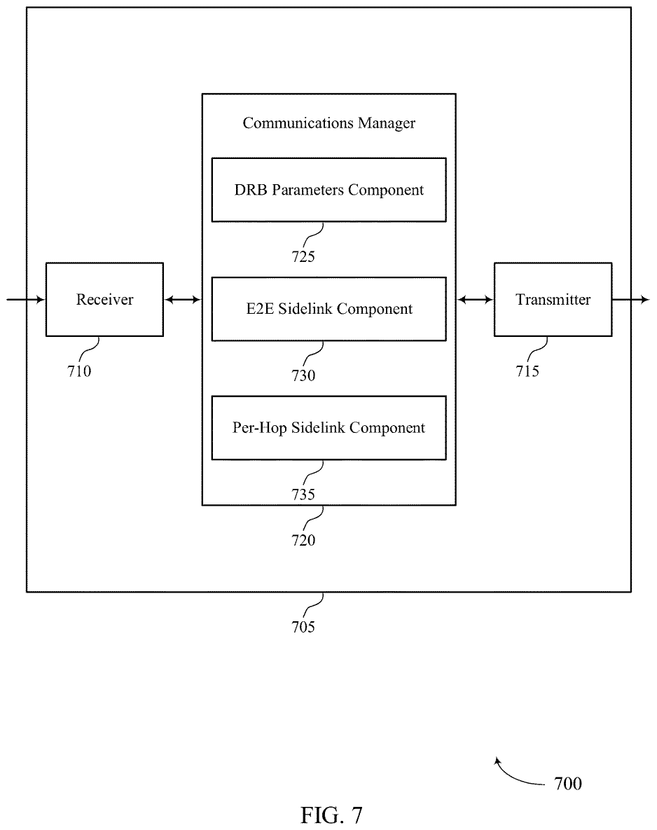

FIG. 7 shows a block diagram 700 of a device 705 that supports enhancements to DRB parameters for U2U relays in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to enhancements to DRB parameters for U2U relays). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to enhancements to DRB parameters for U2U relays). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of enhancements to DRB parameters for U2U relays as described herein. For example, the communications manager 720 may include a DRB parameters component 725, a E2E sidelink component 730, a per-hop sidelink component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a source UE in accordance with examples as disclosed herein. The DRB parameters component 725 is capable of, configured to, or operable to support a means for receiving a control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE. The E2E sidelink component 730 is capable of, configured to, or operable to support a means for transmitting, via a first sidelink interface, control data to the destination UE in accordance with the set of E2E sidelink DRB parameters. The per-hop sidelink component 735 is capable of, configured to, or operable to support a means for transmitting, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops.

The DRB parameters component 725 is capable of, configured to, or operable to support a means for receiving a control message indicating a set of multiple per-hop sidelink DRB parameters, the set of multiple per-hop sidelink DRB parameters associated with a set of multiple communication hops between a source UE and a destination UE. The per-hop sidelink component 735 is capable of, configured to, or operable to support a means for receiving user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops. The per-hop sidelink component 735 is capable of, configured to, or operable to support a means for transmitting the user data via a second sidelink interface in accordance with a second set of per-hop sidelink DRB parameters of the set of multiple per-hop sidelink DRB parameters, the second sidelink interface corresponding to a second communication hop of the set of multiple communication hops.

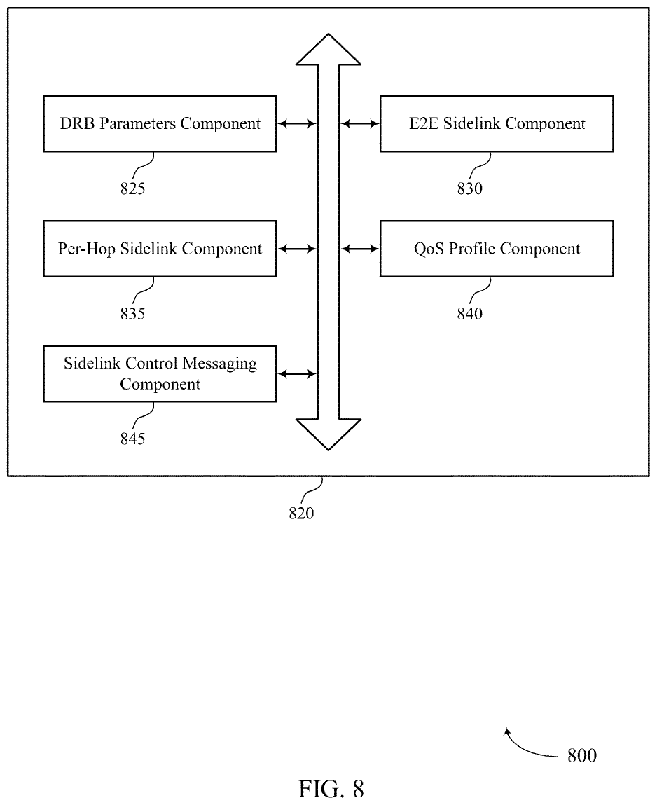

FIG. 8 shows a block diagram 800 of a communications manager 820 that supports enhancements to DRB parameters for U2U relays in accordance with one or more aspects of the present disclosure. The communications manager 820 may be an example of aspects of a communications manager 620, a communications manager 720, or both, as described herein. The communications manager 820, or various components thereof, may be an example of means for performing various aspects of enhancements to DRB parameters for U2U relays as described herein. For example, the communications manager 820 may include a DRB parameters component 825, a E2E sidelink component 830, a per-hop sidelink component 835, a QoS profile component 840, a sidelink control messaging component 845, or any combination thereof. Each of these components may communicate, directly or indirectly, with one another (e.g., via one or more buses).

The communications manager 820 may support wireless communications at a source UE in accordance with examples as disclosed herein. The DRB parameters component 825 is capable of, configured to, or operable to support a means for receiving a control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE. The E2E sidelink component 830 is capable of, configured to, or operable to support a means for transmitting, via a first sidelink interface, control data to the destination UE in accordance with the set of E2E sidelink DRB parameters. The per-hop sidelink component 835 is capable of, configured to, or operable to support a means for transmitting, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops.

In some examples, the QoS profile component 840 is capable of, configured to, or operable to support a means for transmitting a second control message indicating an E2E QoS profile associated with the first sidelink interface, a set of multiple QoS profiles associated with the set of multiple communication hops between the source UE and the destination UE, or both, where the set of E2E sidelink DRB parameters is based on the E2E QoS profile, and where each of the set of multiple per-hop sidelink DRB parameters is based on a respective quality service profile of the set of multiple QoS profiles.

In some examples, the QoS profile component 840 is capable of, configured to, or operable to support a means for transmitting, via the second control message, an indication of a quantity of communication hops of the set of multiple communication hops between the source UE and the destination UE, where the set of multiple per-hop sidelink DRB parameters are further based on the quantity of communication hops of the set of multiple communication hops.

In some examples, the QoS profile component 840 is capable of, configured to, or operable to support a means for receiving, as part of the control message and based on the second control message, an indication of a subset of the set of multiple QoS profiles, the subset of the set of multiple QoS profiles being associated with a subset of the set of multiple communication hops, where the subset of the set of multiple communication hops are subsequent to the first communication hop between the source UE and the relay UE.

In some examples, the QoS profile component 840 is capable of, configured to, or operable to support a means for transmitting, via the second sidelink interface, the subset of the set of multiple QoS profiles to the relay UE.

In some examples, the sidelink control messaging component 845 is capable of, configured to, or operable to support a means for transmitting, to the destination UE, a sidelink control message indicating the set of E2E sidelink DRB parameters based on receiving the control message, where transmitting the control data to the destination UE is based on the sidelink control message.

In some examples, the sidelink control messaging component 845 is capable of, configured to, or operable to support a means for transmitting, to the destination UE, the relay UE, or both, a sidelink control message indicating the set of multiple per-hop sidelink DRB parameters based on receiving the control message, where transmitting the user data via the second sidelink interface is based on the sidelink control message.

In some examples, the control message further indicates that the set of E2E sidelink DRB parameters and the set of multiple per-hop sidelink DRB parameters are for a U2U relay operation.

In some examples, the DRB parameters component 825 is capable of, configured to, or operable to support a means for receiving a control message indicating a set of multiple per-hop sidelink DRB parameters, the set of multiple per-hop sidelink DRB parameters associated with a set of multiple communication hops between a source UE and a destination UE. In some examples, the per-hop sidelink component 835 is capable of, configured to, or operable to support a means for receiving user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops. In some examples, the per-hop sidelink component 835 is capable of, configured to, or operable to support a means for transmitting the user data via a second sidelink interface in accordance with a second set of per-hop sidelink DRB parameters of the set of multiple per-hop sidelink DRB parameters, the second sidelink interface corresponding to a second communication hop of the set of multiple communication hops.

In some examples, the QoS profile component 840 is capable of, configured to, or operable to support a means for transmitting a second control message indicating a set of multiple QoS profiles associated with the set of multiple communication hops between the source UE and the destination UE.

In some examples, the QoS profile component 840 is capable of, configured to, or operable to support a means for transmitting, via the second control message, an indication of a quantity of communication hops of the set of multiple communication hops between the source UE and the destination UE, where the set of multiple per-hop sidelink DRB parameters are further based on the quantity of communication hops of the set of multiple communication hops.

In some examples, the QoS profile component 840 is capable of, configured to, or operable to support a means for receiving, as part of the control message and based on the second control message, an indication of a subset of the set of multiple QoS profiles, the subset of the set of multiple QoS profiles being associated with a subset of the set of multiple communication hops, where in the subset of the set of multiple communication hops are subsequent to the second communication hop.

In some examples, the QoS profile component 840 is capable of, configured to, or operable to support a means for transmitting, via the second sidelink interface, the subset of the set of multiple QoS profiles.

In some examples, the set of multiple QoS profiles includes a first QoS profile associated with the first sidelink interface, a second QoS profile associated with the second sidelink interface, or both.

In some examples, the sidelink control messaging component 845 is capable of, configured to, or operable to support a means for transmitting a sidelink control message indicating the set of multiple per-hop sidelink DRB parameters, where communicating via the first sidelink interface and the second sidelink interface is based on transmitting the sidelink control message.

In some examples, the control message further indicates that the set of multiple per-hop sidelink DRB parameters are for a U2U relay operation.

In some examples, the control message is received from a network entity, the source UE, or both.

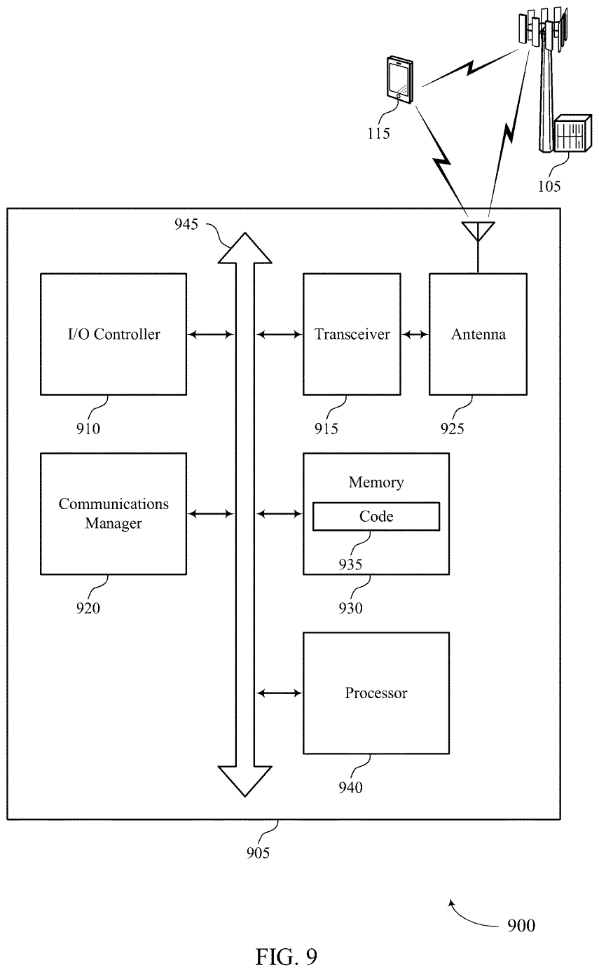

FIG. 9 shows a diagram of a system 900 including a device 905 that supports enhancements to DRB parameters for U2U relays in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting enhancements to DRB parameters for U2U relays). For example, the device 905 or a component of the device 905 may include a processor 940 and memory 930 coupled with or to the processor 940, the processor 940 and memory 930 configured to perform various functions described herein.

The communications manager 920 may support wireless communications at a source UE in accordance with examples as disclosed herein. For example, the communications manager 920 is capable of, configured to, or operable to support a means for receiving a control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE. The communications manager 920 is capable of, configured to, or operable to support a means for transmitting, via a first sidelink interface, control data to the destination UE in accordance with the set of E2E sidelink DRB parameters. The communications manager 920 is capable of, configured to, or operable to support a means for transmitting, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops.

For example, the communications manager 920 is capable of, configured to, or operable to support a means for receiving a control message indicating a set of multiple per-hop sidelink DRB parameters, the set of multiple per-hop sidelink DRB parameters associated with a set of multiple communication hops between a source UE and a destination UE. The communications manager 920 is capable of, configured to, or operable to support a means for receiving user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops. The communications manager 920 is capable of, configured to, or operable to support a means for transmitting the user data via a second sidelink interface in accordance with a second set of per-hop sidelink DRB parameters of the set of multiple per-hop sidelink DRB parameters, the second sidelink interface corresponding to a second communication hop of the set of multiple communication hops.

By including or configuring the communications manager 920 in accordance with examples as described herein, the device 905 may support techniques for a network entity 105 to configure sidelink DRB parameters for multiple communication hops between a source UE and a destination UE and configure sidelink DRB parameters for an E2E link between the source UE and the destination UE, resulting in a more efficient utilization of communication resources and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of enhancements to DRB parameters for U2U relays as described herein, or the processor 940 and the memory 930 may be otherwise configured to perform or support such operations.

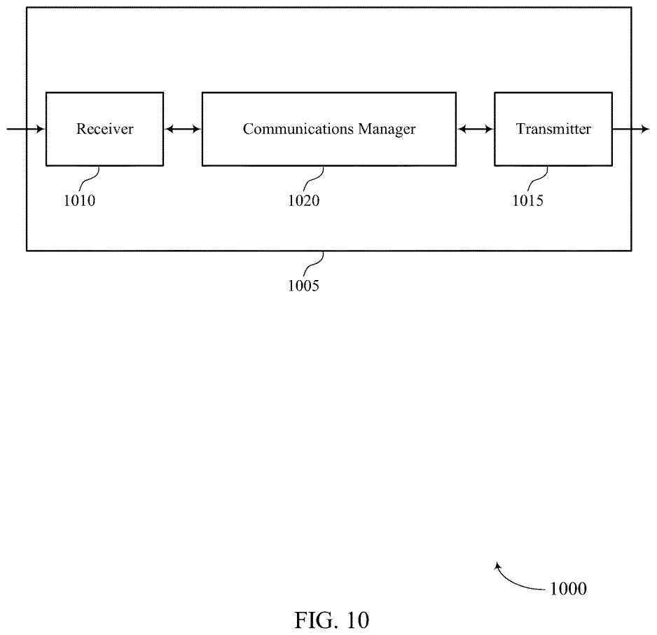

FIG. 10 shows a block diagram 1000 of a device 1005 that supports enhancements to DRB parameters for U2U relays in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas.

Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of enhancements to DRB parameters for U2U relays as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for transmitting, to a source UE, a first control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE. The communications manager 1020 is capable of, configured to, or operable to support a means for transmitting, to a relay UE, a second control message indicating one or more sets of per-hop sidelink DRB parameters of the set of multiple per-hop sidelink DRB parameters based on transmitting the first control message to the source UE.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for a network entity 105 to configure sidelink DRB parameters for multiple communication hops between a source UE and a destination UE and configure sidelink DRB parameters for an E2E link between the source UE and the destination UE, resulting in a more efficient utilization of communication resources.

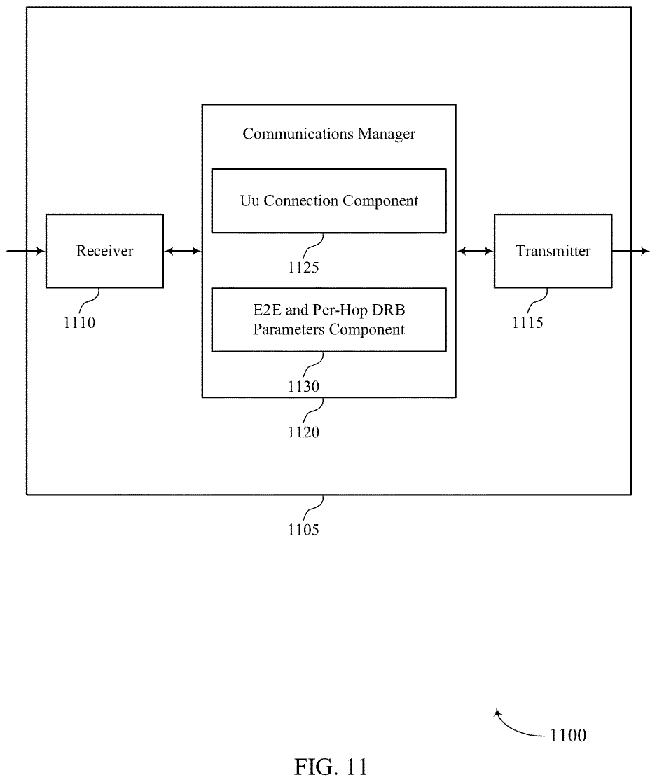

FIG. 11 shows a block diagram 1100 of a device 1105 that supports enhancements to DRB parameters for U2U relays in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas.

Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of enhancements to DRB parameters for U2U relays as described herein. For example, the communications manager 1120 may include an Uu connection component 1125 a E2E and per-hop DRB parameters component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The Uu connection component 1125 is capable of, configured to, or operable to support a means for establishing a wireless connection between the network entity and a source UE. The E2E and per-hop DRB parameters component 1130 is capable of, configured to, or operable to support a means for transmitting, via the wireless connection and to the source UE, a first control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE.

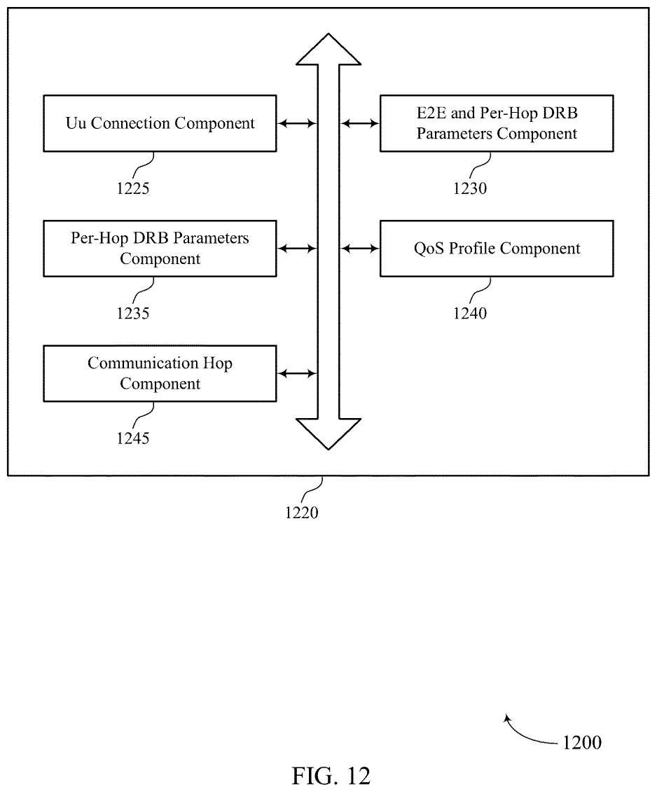

FIG. 12 shows a block diagram 1200 of a communications manager 1220 that supports enhancements to DRB parameters for U2U relays in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of enhancements to DRB parameters for U2U relays as described herein. For example, the communications manager 1220 may include an Uu connection component 1225, a E2E and per-hop DRB parameters component 1230, a per-hop DRB parameters component 1235, a QoS profile component 1240, a communication hop component 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The Uu connection component 1225 is capable of, configured to, or operable to support a means for establishing a wireless connection between the network entity and a source UE. The E2E and per-hop DRB parameters component 1230 is capable of, configured to, or operable to support a means for transmitting, via the wireless connection and to the source UE, a first control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE.

In some examples, the per-hop DRB parameters component 1235 is capable of, configured to, or operable to support a means for transmitting, to a relay UE, a second control message indicating one or more sets of per-hop sidelink DRB parameters of the set of multiple per-hop sidelink DRB parameters based on transmitting the first control message to the source UE.

In some examples, the QoS profile component 1240 is capable of, configured to, or operable to support a means for receiving a third control message indicating an E2E QoS profile associated with a first sidelink interface between the source UE and the destination UE, a set of multiple QoS profiles associated with the set of multiple communication hops between the source UE and the destination UE, or both, where the set of E2E sidelink DRB parameters is based on the E2E QoS profile, and where each of the set of multiple per-hop sidelink DRB parameters is based on a respective quality service profile of the set of multiple QoS profiles.

In some examples, the communication hop component 1245 is capable of, configured to, or operable to support a means for receiving, via the third control message, an indication of a quantity of communication hops of the set of multiple communication hops between the source UE and the destination UE, where the set of multiple per-hop sidelink DRB parameters are further based on the quantity of communication hops of the set of multiple communication hops.

In some examples, the communication hop component 1245 is capable of, configured to, or operable to support a means for transmitting, based on the second control message, an indication of a subset of the set of multiple QoS profiles, the subset of the set of multiple QoS profiles being associated with a subset of the set of multiple communication hops, where the subset of the set of multiple communication hops are subsequent to a first communication hop between the source UE and the relay UE.

In some examples, the first control message and the second control message further indicate that the set of multiple per-hop sidelink DRB parameters are for a U2U relay operation.

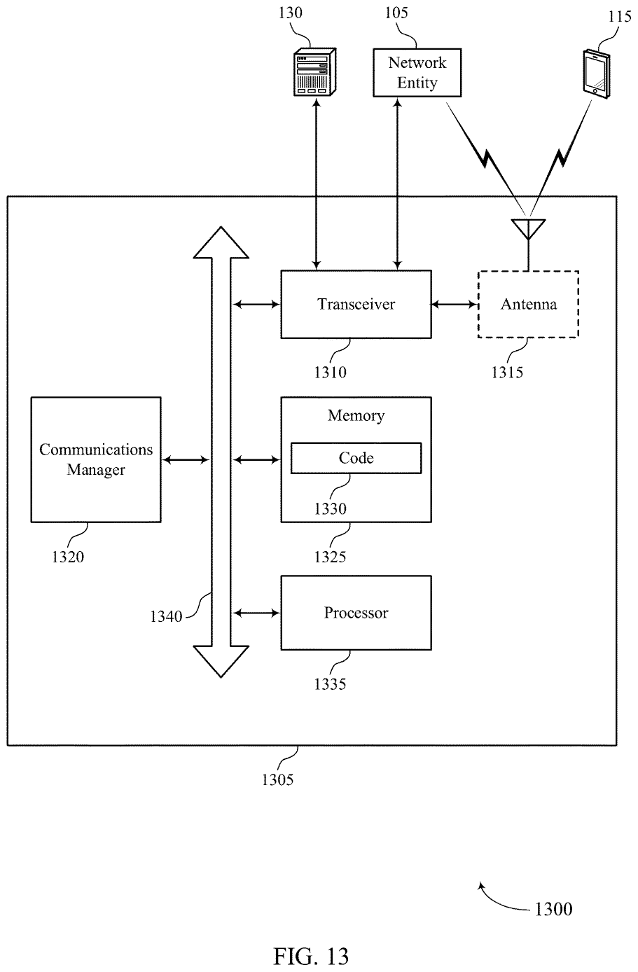

FIG. 13 shows a diagram of a system 1300 including a device 1305 that supports enhancements to DRB parameters for U2U relays in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting enhancements to DRB parameters for U2U relays). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

For example, the communications manager 1320 is capable of, configured to, or operable to support a means for transmitting, to a source UE, a first control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE. The communications manager 1320 is capable of, configured to, or operable to support a means for transmitting, to a relay UE, a second control message indicating one or more sets of per-hop sidelink DRB parameters of the set of multiple per-hop sidelink DRB parameters based on transmitting the first control message to the source UE.

By including or configuring the communications manager 1320 in accordance with examples as described herein, the device 1305 may support techniques for a network entity 105 to configure sidelink DRB parameters for multiple communication hops between a source UE and a destination UE and configure sidelink DRB parameters for an E2E link between the source UE and the destination UE, resulting in a more efficient utilization of communication resources and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of enhancements to DRB parameters for U2U relays as described herein, or the processor 1335 and the memory 1325 may be otherwise configured to perform or support such operations.

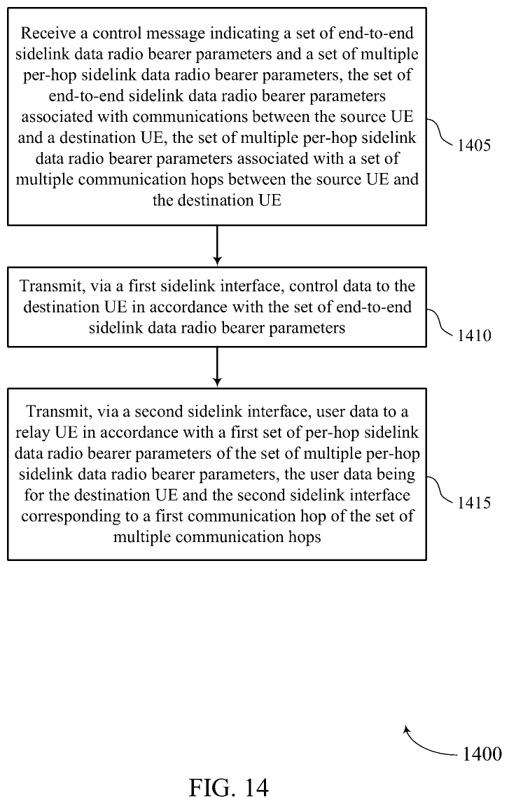

FIG. 14 shows a flowchart illustrating a method 1400 that supports enhancements to DRB parameters for U2U relays in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE. The operations of block 1405 may be performed in accordance with examples as disclosed herein. In some examples, aspects of the operations of 1405 may be performed by a DRB parameters component 825 as described with reference to FIG. 8.

At 1410, the method may include transmitting, via a first sidelink interface, control data to the destination UE in accordance with the set of E2E sidelink DRB parameters. The operations of block 1410 may be performed in accordance with examples as disclosed herein. In some examples, aspects of the operations of 1410 may be performed by a E2E sidelink component 830 as described with reference to FIG. 8.

At 1415, the method may include transmitting, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops. The operations of block 1415 may be performed in accordance with examples as disclosed herein. In some examples, aspects of the operations of 1415 may be performed by a per-hop sidelink component 835 as described with reference to FIG. 8.

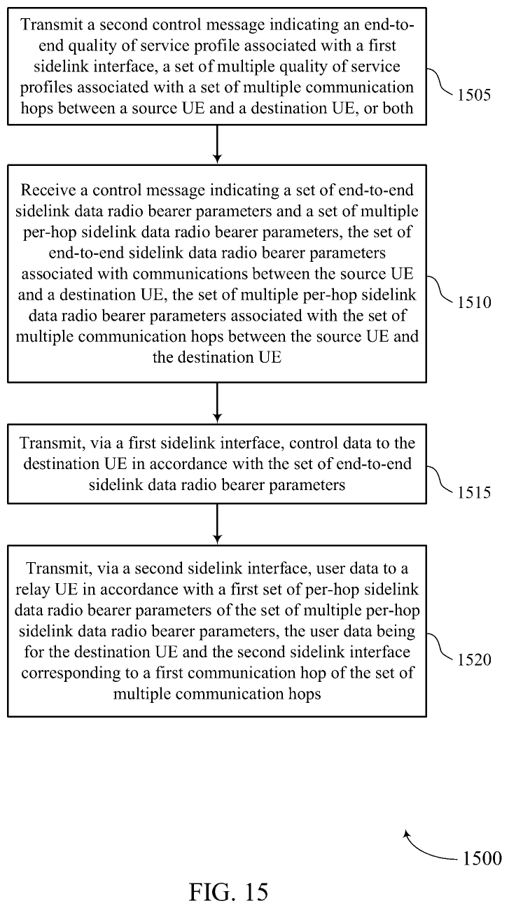

FIG. 15 shows a flowchart illustrating a method 1500 that supports enhancements to DRB parameters for U2U relays in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a second control message indicating an E2E QoS profile associated with a first sidelink interface, a set of multiple QoS profiles associated with a set of multiple communication hops between a source UE and a destination UE, or both. The operations of block 1505 may be performed in accordance with examples as disclosed herein. In some examples, aspects of the operations of 1505 may be performed by a QoS profile component 840 as described with reference to FIG. 8.

At 1510, the method may include receiving a control message indicating a set of E2E sidelink DRB parameters and a set of multiple per-hop sidelink DRB parameters, the set of E2E sidelink DRB parameters associated with communications between the source UE and the destination UE, the set of multiple per-hop sidelink DRB parameters associated with the set of multiple communication hops between the source UE and the destination UE, where the set of E2E sidelink DRB parameters is based on the E2E QoS profile, and where each of the set of multiple per-hop sidelink DRB parameters is based on a respective quality service profile of the set of multiple QoS profiles. The operations of block 1510 may be performed in accordance with examples as disclosed herein. In some examples, aspects of the operations of 1510 may be performed by a DRB parameters component 825 as described with reference to FIG. 8.

At 1515, the method may include transmitting, via a first sidelink interface, control data to the destination UE in accordance with the set of E2E sidelink DRB parameters. The operations of block 1515 may be performed in accordance with examples as disclosed herein. In some examples, aspects of the operations of 1515 may be performed by a E2E sidelink component 830 as described with reference to FIG. 8.

At 1520, the method may include transmitting, via a second sidelink interface, user data to a relay UE in accordance with a first set of per-hop sidelink DRB parameters of the set of multiple per-hop sidelink DRB parameters, the user data being for the destination UE and the second sidelink interface corresponding to a first communication hop of the set of multiple communication hops. The operations of block 1520 may be performed in accordance with examples as disclosed herein. In some examples, aspects of the operations of 1520 may be performed by a per-hop sidelink component 835 as described with reference to FIG. 8.

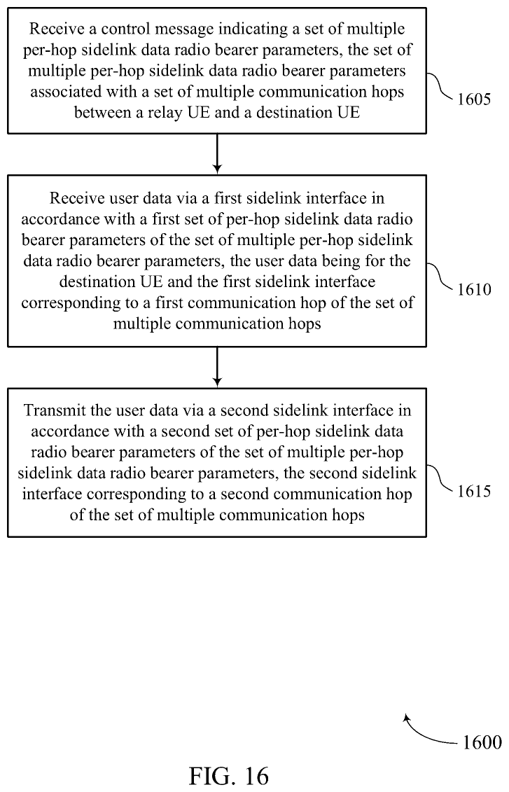

FIG. 16 shows a flowchart illustrating a method 1600 that supports enhancements to DRB parameters for U2U relays in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating a set of multiple per-hop sidelink DRB parameters, the set of multiple per-hop sidelink DRB parameters associated with a set of multiple communication hops between a relay UE and a destination UE. The operations of block 1605 may be performed in accordance with examples as disclosed herein. In some examples, aspects of the operations of 1605 may be performed by a DRB parameters component 825 as described with reference to FIG. 8.

At 1610, the method may include receiving user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops. The operations of block 1610 may be performed in accordance with examples as disclosed herein. In some examples, aspects of the operations of 1610 may be performed by a per-hop sidelink component 835 as described with reference to FIG. 8.

At 1615, the method may include transmitting the user data via a second sidelink interface in accordance with a second set of per-hop sidelink DRB parameters of the set of multiple per-hop sidelink DRB parameters, the second sidelink interface corresponding to a second communication hop of the set of multiple communication hops. The operations of block 1615 may be performed in accordance with examples as disclosed herein. In some examples, aspects of the operations of 1615 may be performed by a per-hop sidelink component 835 as described with reference to FIG. 8.

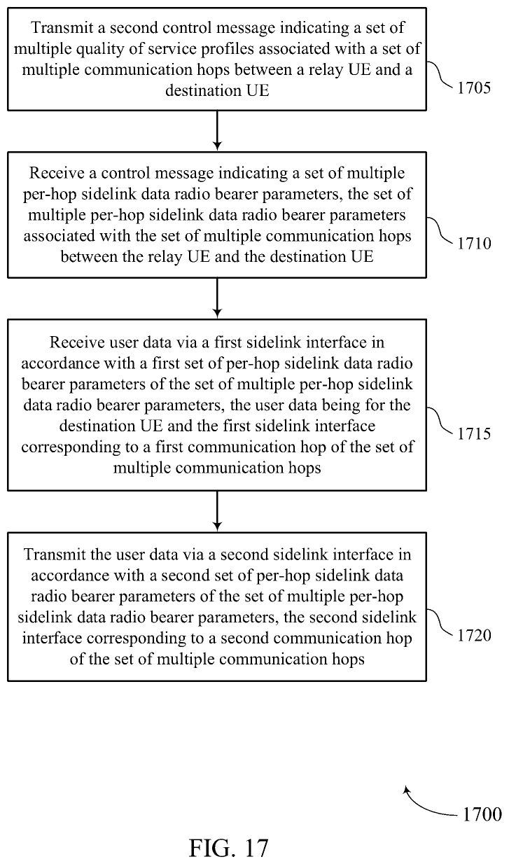

FIG. 17 shows a flowchart illustrating a method 1700 that supports enhancements to DRB parameters for U2U relays in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include transmitting a second control message indicating a set of multiple QoS profiles associated with a set of multiple communication hops between a relay UE and a destination UE. The operations of block 1705 may be performed in accordance with examples as disclosed herein. In some examples, aspects of the operations of 1705 may be performed by a QoS profile component 840 as described with reference to FIG. 8.

At 1710, the method may include receiving a control message indicating a set of multiple per-hop sidelink DRB parameters, the set of multiple per-hop sidelink DRB parameters associated with the set of multiple communication hops between the relay UE and the destination UE. The operations of block 1710 may be performed in accordance with examples as disclosed herein. In some examples, aspects of the operations of 1710 may be performed by a DRB parameters component 825 as described with reference to FIG. 8.

At 1715, the method may include receiving user data via a first sidelink interface in accordance with a first set of per-hop sidelink DRB parameters of the set of multiple per-hop sidelink DRB parameters, the user data being for the destination UE and the first sidelink interface corresponding to a first communication hop of the set of multiple communication hops. The operations of block 1715 may be performed in accordance with examples as disclosed herein. In some examples, aspects of the operations of 1715 may be performed by a per-hop sidelink component 835 as described with reference to FIG. 8.

At 1720, the method may include transmitting the user data via a second sidelink interface in accordance with a second set of per-hop sidelink DRB parameters of the set of multiple per-hop sidelink DRB parameters, the second sidelink interface corresponding to a second communication hop of the set of multiple communication hops. The operations of block 1720 may be performed in accordance with examples as disclosed herein. In some examples, aspects of the operations of 1720 may be performed by a per-hop sidelink component 835 as described with reference to FIG. 8.

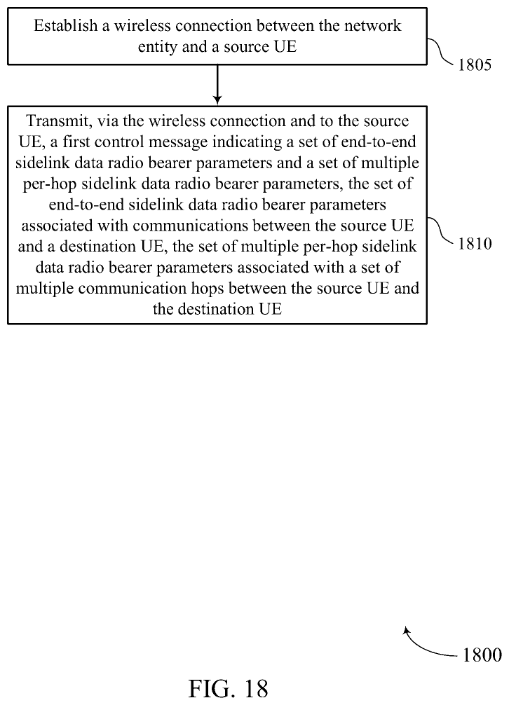

FIG. 18 shows a flowchart illustrating a method 1800 that supports enhancements to DRB parameters for U2U relays in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include establishing a wireless connection between the network entity and a source UE. The operations of block 1805 may be performed in accordance with examples as disclosed herein. In some examples, aspects of the operations of 1805 may be performed by an Uu connection component 1225 as described with reference to FIG. 12.

At 1810, the method may include transmitting, via the wireless connection and to the source UE, a first control message indicating a set of E2E sidelink DRB parameters and a set of multiple per-hop sidelink DRB parameters, the set of E2E sidelink DRB parameters associated with communications between the source UE and a destination UE, the set of multiple per-hop sidelink DRB parameters associated with a set of multiple communication hops between the source UE and the destination UE. The operations of block 1810 may be performed in accordance with examples as disclosed herein. In some examples, aspects of the operations of 1810 may be performed by a E2E and per-hop DRB parameters component 1230 as described with reference to FIG. 12.

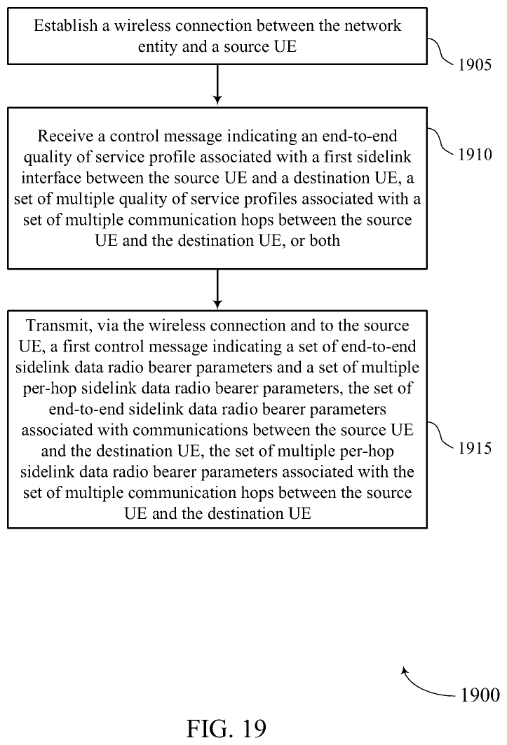

FIG. 19 shows a flowchart illustrating a method 1900 that supports enhancements to DRB parameters for U2U relays in accordance with aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include establishing a wireless connection between the network entity and a source UE. The operations of block 1905 may be performed in accordance with examples as disclosed herein. In some examples, aspects of the operations of 1905 may be performed by an Uu connection component 1225 as described with reference to FIG. 12.

At 1910, the method may include receiving a control message indicating an E2E QoS profile associated with a first sidelink interface between the source UE and a destination UE, a set of multiple QoS profiles associated with a set of multiple communication hops between the source UE and the destination UE, or both. The operations of block 1910 may be performed in accordance with examples as disclosed herein. In some examples, aspects of the operations of 1910 may be performed by a QoS profile component 1240 as described with reference to FIG. 12.

At 1915, the method may include transmitting, via the wireless connection and to the source UE, a control message indicating a set of E2E sidelink DRB parameters and a set of multiple per-hop sidelink DRB parameters, the set of E2E sidelink DRB parameters associated with communications between the source UE and the destination UE, the set of multiple per-hop sidelink DRB parameters associated with the set of multiple communication hops between the source UE and the destination UE, where the set of E2E sidelink DRB parameters is based on the E2E QoS profile, and where each of the set of multiple per-hop sidelink DRB parameters is based on a respective quality service profile of the set of multiple QoS profiles. The operations of block 1915 may be performed in accordance with examples as disclosed herein. In some examples, aspects of the operations of 1915 may be performed by a E2E and per-hop DRB parameters component 1230 as described with reference to FIG. 12.

The following provides an overview of aspects of the present disclosure:
Aspect 1: A method for wireless communications at a source UE, comprising: receiving a control message indicating a set of E2E sidelink DRB parameters and a plurality of per-hop sidelink DRB parameters, the set of E2E sidelink DRB parameters associated with communications between the source UE and a destination UE, the plurality of per-hop sidelink DRB parameters associated with a plurality of communication hops between the source UE and the destination UE; transmitting, via a first sidelink interface, control data to the destination UE in accordance with the set of E2E sidelink DRB parameters; and transmitting, via a second sidelink interface, user data to a relay UE in accordance with a first set of per-hop sidelink DRB parameters of the plurality of per-hop sidelink DRB parameters, the user data being for the destination UE and the second sidelink interface corresponding to a first communication hop of the plurality of communication hops.
Aspect 2: The method of aspect 1, further comprising: transmitting a second control message indicating an E2E QoS profile associated with the first sidelink interface, a plurality of QoS profiles associated with the plurality of communication hops between the source UE and the destination UE, or both, wherein the set of E2E sidelink DRB parameters is based at least in part on the E2E QoS profile, and wherein each of the plurality of per-hop sidelink DRB parameters is based at least in part on a respective quality service profile of the plurality of QoS profiles.
Aspect 3: The method of aspect 2, further comprising: transmitting, via the second control message, an indication of a quantity of communication hops of the plurality of communication hops between the source UE and the destination UE, wherein the plurality of per-hop sidelink DRB parameters are further based at least in part on the quantity of communication hops of the plurality of communication hops.
Aspect 4: The method of any of aspects 2 through 3, further comprising: receiving, as part of the control message and based at least in part on the second control message, an indication of a first QoS profile of the plurality of QoS profiles and a subset of the plurality of QoS profiles, the first QoS profile being associated with the first communication hop between the source UE and the relay, and the subset of the plurality of QoS profiles being associated with a subset of the plurality of communication hops, wherein the subset of the plurality of communication hops are between the relay UE and the destination UE.
Aspect 5: The method of aspect 4, further comprising: transmitting, via the second sidelink interface, the subset of the plurality of QoS profiles to the relay UE.
Aspect 6: The method of any of aspects 1 through 5, further comprising: transmitting, to the destination UE, a sidelink control message indicating the set of E2E sidelink DRB parameters based at least in part on receiving the control message, wherein transmitting the control data to the destination UE is based at least in part on the sidelink control message.
Aspect 7: The method of any of aspects 1 through 6, further comprising: transmitting, to the destination UE, the relay UE, or both, a sidelink control message indicating the plurality of per-hop sidelink DRB parameters based at least in part on receiving the control message, wherein transmitting the user data via the second sidelink interface is based at least in part on the sidelink control message.
Aspect 8: The method of any of aspects 1 through 7, wherein the control message further indicates that the set of E2E sidelink DRB parameters and the plurality of per-hop sidelink DRB parameters are for a UE-to-UE relay operation.
Aspect 9: A method of wireless communications at a relay UE, comprising: receiving a control message indicating a plurality of per-hop sidelink DRB parameters, the plurality of per-hop sidelink DRB parameters associated with a plurality of communication hops between the relay UE and a destination UE; receiving user data via a first sidelink interface in accordance with a first set of per-hop sidelink DRB parameters of the plurality of per-hop sidelink DRB parameters, the user data being for the destination UE and the first sidelink interface corresponding to a first communication hop of the plurality of communication hops; and transmitting the user data via a second sidelink interface in accordance with a second set of per-hop sidelink DRB parameters of the plurality of per-hop sidelink DRB parameters, the second sidelink interface corresponding to a second communication hop of the plurality of communication hops.
Aspect 10: The method of aspect 9, further comprising: transmitting a second control message indicating a plurality of QoS profiles associated with the plurality of communication hops between the relay UE and the destination UE.
Aspect 11: The method of aspect 10, further comprising: transmitting, via the second control message, an indication of a quantity of communication hops of the plurality of communication hops between the relay UE and the destination UE.
Aspect 12: The method of any of aspects 10 through 11, further comprising: receiving, as part of the control message and based at least in part on the second control message, an indication of a subset of the plurality of QoS profiles, the subset of the plurality of QoS profiles being associated with a subset of the plurality of communication hops, where in the subset of the plurality of communication hops are subsequent to the second communication hop.
Aspect 13: The method of aspect 12, further comprising: transmitting, via the second sidelink interface, the subset of the plurality of QoS profiles.
Aspect 14: The method of any of aspects 10 through 13, wherein the plurality of QoS profiles includes a first QoS profile associated with the first sidelink interface, a second QoS profile associated with the second sidelink interface, or both.
Aspect 15: The method of any of aspects 9 through 14, further comprising: transmitting a sidelink control message indicating the plurality of per-hop sidelink DRB parameters, wherein communicating via the first sidelink interface and the second sidelink interface is based at least in part on transmitting the sidelink control message.
Aspect 16: The method of any of aspects 9 through 15, wherein the control message further indicates that the plurality of per-hop sidelink DRB parameters are for a UE-to-UE relay operation.
Aspect 17: The method of any of aspects 9 through 16, wherein the control message is received from a network entity, the source UE, or both.
Aspect 18: A method of wireless communications at a network entity, comprising: establishing a wireless connection between the network entity and a source UE; and transmitting, via the wireless connection and to the source UE, a first control message indicating a set of E2E sidelink DRB parameters and a plurality of per-hop sidelink DRB parameters, the set of E2E sidelink DRB parameters associated with communications between the source UE and a destination UE, the plurality of per-hop sidelink DRB parameters associated with a plurality of communication hops between the source UE and the destination UE; and Aspect 19: The method of aspect 18, further comprising: transmitting, to a relay UE, a second control message indicating one or more sets of per-hop sidelink DRB parameters of the plurality of per-hop sidelink DRB parameters based at least in part on transmitting the first control message to the source UE.
Aspect 20: The method of any of aspects 18 through 19, further comprising: receiving a third control message indicating an E2E QoS profile associated with a first sidelink interface between the source UE and the destination UE, a plurality of QoS profiles associated with the plurality of communication hops between the source UE and the destination UE, or both, wherein the set of E2E sidelink DRB parameters is based at least in part on the E2E QoS profile, and wherein each of the plurality of per-hop sidelink DRB parameters is based at least in part on a respective quality service profile of the plurality of QoS profiles.
Aspect 21: The method of aspect 20, further comprising: receiving, via the third control message, an indication of a quantity of communication hops of the plurality of communication hops between the source UE and the destination UE, wherein the plurality of per-hop sidelink DRB parameters are further based at least in part on the quantity of communication hops of the plurality of communication hops.
Aspect 22: The method of any of aspects 20 through 21, further comprising: transmitting, based at least in part on the second control message, an indication of a subset of the plurality of QoS profiles, the subset of the plurality of QoS profiles being associated with a subset of the plurality of communication hops, wherein the subset of the plurality of communication hops are subsequent to a first communication hop between the source UE and the relay UE.
Aspect 23: The method of any of aspects 18 through 22, wherein the first control message and the second control message further indicate that the plurality of per-hop sidelink DRB parameters are for a UE-to-UE relay operation.
Aspect 24: An apparatus for wireless communications at a source UE, comprising a processor; memory coupled with the processor; and instructions stored in the memory and executable by the processor to cause the apparatus to perform a method of any of aspects 1 through 8.
Aspect 25: An apparatus for wireless communications at a source UE, comprising at least one means for performing a method of any of aspects 1 through 8.
Aspect 26: A non-transitory computer-readable medium storing code for wireless communications at a source UE, the code comprising instructions executable by a processor to perform a method of any of aspects 1 through 8.
Aspect 27: An apparatus comprising a processor; memory coupled with the processor; and instructions stored in the memory and executable by the processor to cause the apparatus to perform a method of any of aspects 9 through 17.
Aspect 28: An apparatus comprising at least one means for performing a method of any of aspects 9 through 17.
Aspect 29: A non-transitory computer-readable medium storing code the code comprising instructions executable by a processor to perform a method of any of aspects 9 through 17.
Aspect 30: An apparatus comprising a processor; memory coupled with the processor; and instructions stored in the memory and executable by the processor to cause the apparatus to perform a method of any of aspects 18 through 23.
Aspect 31: An apparatus comprising at least one means for performing a method of any of aspects 18 through 23.
Aspect 32: A non-transitory computer-readable medium storing code the code comprising instructions executable by a processor to perform a method of any of aspects 18 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

Also, as used herein, the phrase “a set” shall be construed as including the possibility of a set with one member. That is, the phrase “a set” shall be construed in the same manner as “one or more.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a source user equipment (UE), comprising:
a processor;
memory coupled with the processor; and
instructions stored in the memory and executable by the processor to cause the apparatus to:
receive a control message indicating a set of end-to-end sidelink data radio bearer parameters and a plurality of per-hop sidelink data radio bearer parameters, the set of end-to-end sidelink data radio bearer parameters associated with communications between the source UE and a destination UE, the plurality of per-hop sidelink data radio bearer parameters associated with a plurality of communication hops between the source UE and the destination UE;
transmit, via a first sidelink interface, control data to the destination UE in accordance with the set of end-to-end sidelink data radio bearer parameters; and
transmit, via a second sidelink interface, user data to a relay UE in accordance with a first set of per-hop sidelink data radio bearer parameters of the plurality of per-hop sidelink data radio bearer parameters, the user data being for the destination UE and the second sidelink interface corresponding to a first communication hop of the plurality of communication hops.

2. The apparatus of claim 1, wherein the instructions are further executable by the processor to cause the apparatus to:
transmit a second control message indicating an end-to-end quality of service profile associated with the first sidelink interface, a plurality of quality of service profiles associated with the plurality of communication hops between the source UE and the destination UE, or both, wherein the set of end-to-end sidelink data radio bearer parameters is based at least in part on the end-to-end quality of service profile, and wherein each of the plurality of per-hop sidelink data radio bearer parameters is based at least in part on a respective quality service profile of the plurality of quality of service profiles.

3. The apparatus of claim 2, wherein the instructions are further executable by the processor to cause the apparatus to:
transmit, via the second control message, an indication of a quantity of communication hops of the plurality of communication hops between the source UE and the destination UE, wherein the plurality of per-hop sidelink data radio bearer parameters are further based at least in part on the quantity of communication hops of the plurality of communication hops.

4. The apparatus of claim 2, wherein the instructions are further executable by the processor to cause the apparatus to:
receive, as part of the control message and based at least in part on the second control message, an indication of a first quality of service profile of the plurality of quality of service profiles and a subset of the plurality of quality of service profiles, the first quality of service profile being associated with the first communication hop between the source UE and the relay UE, and the subset of the plurality of quality of service profiles being associated with a subset of the plurality of communication hops, wherein the subset of the plurality of communication hops are between the relay UE and the destination UE.

5. The apparatus of claim 4, wherein the instructions are further executable by the processor to cause the apparatus to:
transmit, via the second sidelink interface, the subset of the plurality of quality of service profiles to the relay UE.

6. The apparatus of claim 1, wherein the instructions are further executable by the processor to cause the apparatus to:
transmit, to the destination UE, a sidelink control message indicating the set of end-to-end sidelink data radio bearer parameters based at least in part on receiving the control message, wherein transmitting the control data to the destination UE is based at least in part on the sidelink control message.

7. The apparatus of claim 1, wherein the instructions are further executable by the processor to cause the apparatus to:
transmit, to the destination UE, the relay UE, or both, a sidelink control message indicating the plurality of per-hop sidelink data radio bearer parameters based at least in part on receiving the control message, wherein transmitting the user data via the second sidelink interface is based at least in part on the sidelink control message.

8. The apparatus of claim 1, wherein the control message further indicates that the set of end-to-end sidelink data radio bearer parameters and the plurality of per-hop sidelink data radio bearer parameters are for a UE-to-UE relay operation.

9. An apparatus for wireless communications at a relay user equipment (UE), comprising:
a processor;
memory coupled with the processor; and
instructions stored in the memory and executable by the processor to cause the apparatus to:
receive a control message indicating a plurality of per-hop sidelink data radio bearer parameters, the plurality of per-hop sidelink data radio bearer parameters associated with a plurality of communication hops between the relay UE and a destination UE;
receive user data via a first sidelink interface in accordance with a first set of per-hop sidelink data radio bearer parameters of the plurality of per-hop sidelink data radio bearer parameters, the user data being for the destination UE and the first sidelink interface corresponding to a first communication hop of the plurality of communication hops; and
transmit the user data via a second sidelink interface in accordance with a second set of per-hop sidelink data radio bearer parameters of the plurality of per-hop sidelink data radio bearer parameters, the second sidelink interface corresponding to a second communication hop of the plurality of communication hops.

10. The apparatus of claim 9, wherein the instructions are further executable by the processor to cause the apparatus to:
transmit a second control message indicating a plurality of quality of service profiles associated with the plurality of communication hops between the relay UE and the destination UE.

11. The apparatus of claim 10, wherein the instructions are further executable by the processor to cause the apparatus to:
transmit, via the second control message, an indication of a quantity of communication hops of the plurality of communication hops between the relay UE and the destination UE.

12. The apparatus of claim 10, wherein the instructions are further executable by the processor to cause the apparatus to:
receive, as part of the control message and based at least in part on the second control message, an indication of a subset of the plurality of quality of service profiles, the subset of the plurality of quality of service profiles being associated with a subset of the plurality of communication hops, wherein the subset of the plurality of communication hops are subsequent to the second communication hop.

13. The apparatus of claim 12, wherein the instructions are further executable by the processor to cause the apparatus to:
transmit, via the second sidelink interface, the subset of the plurality of quality of service profiles.

14. The apparatus of claim 10, wherein the plurality of quality of service profiles includes a first quality of service profile associated with the first sidelink interface, a second quality of service profile associated with the second sidelink interface, or both.

15. The apparatus of claim 9, wherein the instructions are further executable by the processor to cause the apparatus to:
transmit a sidelink control message indicating the plurality of per-hop sidelink data radio bearer parameters, wherein communicating via the first sidelink interface and the second sidelink interface is based at least in part on transmitting the sidelink control message.

16. The apparatus of claim 9, wherein the control message further indicates that the plurality of per-hop sidelink data radio bearer parameters are for a UE-to-UE relay operation.

17. The apparatus of claim 9, wherein the control message is received from a network entity, a source UE, or both.

18. An apparatus for wireless communications at a network entity, comprising:
a processor;
memory coupled with the processor; and
instructions stored in the memory and executable by the processor to cause the apparatus to:
establish a wireless connection between the network entity and a source user equipment (UE); and
transmit, via the wireless connection and to the source UE, a first control message indicating a set of end-to-end sidelink data radio bearer parameters and a plurality of per-hop sidelink data radio bearer parameters, the set of end-to-end sidelink data radio bearer parameters associated with communications between the source UE and a destination UE, the plurality of per-hop sidelink data radio bearer parameters associated with a plurality of communication hops between the source UE and the destination UE.

19. The apparatus of claim 18, wherein the instructions are further executable by the processor to cause the apparatus to:
transmit, to a relay UE, a second control message indicating one or more sets of per-hop sidelink data radio bearer parameters of the plurality of per-hop sidelink data radio bearer parameters.

20-23. (canceled)

24. A method for wireless communications at a source user equipment (UE), comprising:
receiving a control message indicating a set of end-to-end sidelink data radio bearer parameters and a plurality of per-hop sidelink data radio bearer parameters, the set of end-to-end sidelink data radio bearer parameters associated with communications between the source UE and a destination UE, the plurality of per-hop sidelink data radio bearer parameters associated with a plurality of communication hops between the source UE and the destination UE;
transmitting, via a first sidelink interface, control data to the destination UE in accordance with the set of end-to-end sidelink data radio bearer parameters; and
transmitting, via a second sidelink interface, user data to a relay UE in accordance with a first set of per-hop sidelink data radio bearer parameters of the plurality of per-hop sidelink data radio bearer parameters, the user data being for the destination UE and the second sidelink interface corresponding to a first communication hop of the plurality of communication hops.

25-30. (canceled)
